(19) United States
(12) Patent Application Publication
(10) Pub. No.: US 2016/0145030 A1
(43) Pub. Date: May 26, 2016

(54) SYSTEMS AND METHODS FOR PACKAGING FOODS WITH DISPARATE WATER ACTIVITY VALUES

(71) Applicant: KOOEE! Super Snacks Inc., San Francisco, CA (US)

(72) Inventors: Shaun Malligan, San Francisco, CA (US); Natalie Malligan, San Francisco, CA (US); Jamie Gene Stearns, Boulder, CO (US); Arianna Toft-Stearns, Boulder, CO (US)

(73) Assignee: KOOEE! Super Snacks Inc., San Francisco, CA (US)

(21) Appl. No.: 14/859,239

(22) Filed: Sep. 18, 2015

Related U.S. Application Data
(60) Provisional application No. 62/052,222, filed on Sep. 18, 2014.

(51) Int. Cl. B65D 81/32; B65D 75/30; B65B 51/02; B65D 65/14; B65B 7/02; B65B 51/10

(52) U.S. Cl. CPC B65D 81/3266; A23L 1/31; A23L 1/362; A23L 1/2123; B65B 7/02; B65B 51/10; B65B 51/02; B65D 65/14; B65D 75/30; A23V 2002/00

(57) ABSTRACT

There is presented a method and systems and methods for packaging foods with disparate water activity values, whereby an environment is presented to preserve substances, such as foodstuffs, by preventing unwanted water transfer between them within a multi-compartment package. Such a container may include a first inner compartment and a second inner compartment defined within an interior volume of the container; an opening mechanism to provide access to the contents of the two or more inner compartments; and wherein the first and second inner compartments are sealed and segregated to prevent migration of water from a first provided foodstuff stored within the first compartment to a second provided foodstuff stored within the second compartment.

### CROSS REFERENCE TO RELATED APPLICATIONS

This application claims priority to U.S. Provisional Patent Application Ser. No. 62/052,222 filed Sep. 18, 2014, titled, “Flexible Packaging Bag,” the disclosure of which is fully incorporated herein by reference for all purposes.

### DESCRIPTION OF THE INVENTION

### Field of the Invention

The present invention provides for systems and methods for packaging foodstuffs in multi-compartment packages. More particularly, embodiments of the present invention provide for flexible packaging bags that are particularly suitable, though not exclusively, for packaging foods for being mixed together in use prior to consumption. Additionally, various embodiments provide for the packaging of a plurality of food types that have disparate water activity values, and partitioning such foods within a package to provide for an optimal preservation environment while allowing ease of consumption of a mixed product.

2. Background of the Invention

The water activity (a_{w}) of a food is the ratio between the vapor pressure of the food itself, when in a completely undisturbed balance with the surrounding air media, and the vapor pressure of distilled water under identical conditions. The values of water activity a_{w} range between 0 and 1, and for example, a water activity of 0.80 means the vapor pressure is 80 percent of that of pure water. Proper control of water activity in food products is particularly important in maximizing shelf life and stability of food products, in addition to other products such as pharmaceuticals and cosmetics.

In general, consumer food products with higher water activities will typically have a shorter shelf life than products with lower water activities. Water activity not only affects the shelf life of a product, but is also a key concern in safety, texture, flavor, and aroma of foods. While temperature, pH and several other factors can influence if and how fast organisms will grow in a product, water activity may be the most important factor in controlling spoilage. Most bacteria, for example, do not grow at water activities below 0.91, and most molds cease to grow at water activities below 0.80. Water activity a_{w}—not water content—determines the lower limit of available water for microbial growth. In addition to influencing microbial spoilage, water activity can play a significant role in determining the activity of enzymes and vitamins in foods and thus has a major impact their color, taste, and aroma. Additionally, a_{w} can also significantly impact the potency and consistency of pharmaceuticals.

In any given category of food products, there will be a category-specific water activity that food manufacturers must achieve (i.e., keep under) to obtain the necessary shelf life and product quality. As most foods have a water activity above 0.95, conditions will be present that provide sufficient moisture to support the growth of bacteria, yeasts, and mold. As part of the manufacturing process, the amount of available moisture can be reduced to a point which will inhibit the growth of the organisms. If the water activity of food is controlled to 0.85 or less in the finished product, it is not subject to the regulations of U.S. Regulations 21 C.F.R. Parts 108, 113, and 114. As such, control of a_{w} is commonly used as a “critical control point” in a food safety plan, so if the value is not achieved, then the food is not suitable for sale or consumption.

It is known that water migrates from areas of high a_{w} to areas of low a_{w}. For that reason, consumer product packages are designed in many cases to prevent unwanted adsorption of humidity from atmospheric sources and thereby maintain the a_{w} in manufactured food products at a level intended by the suppliers. However, multicomponent products present a further challenge, because as water moves from ingredients within a package container from foods with a high a_{w} to ingredients with low a_{w} the equalization of water may result in a_{w} values in at least some of the food products that may either lead to spoilage (higher than intended a_{w}) or undesirable texture or dryness (lower than intended a_{w}). This impacts product quality, as ingredients that were once dry will become soggy, and ingredients that were originally moist can be dried out. Furthermore, ingredients that were originally in the appropriate water activity range may degrade quickly due to an increased water activity caused by the movement of water. As a consequence, most multicomponent products will be comprised of products with similar a_{w}.

Trail mixes provide a healthy snack for hikers and other outdoor enthusiasts and commonly contain processed snack foods (e.g., cookies, pretzels), and nuts, seeds and dried fruits such as one or more of sultanas, currants and raisins. Trail mixes can also contain other foods such as chocolate pieces or jerky. Jerky is meat that has been trimmed of fat, optionally treated with preservatives or hygroscopics like salt or sugar, then dried to delay spoilage. While beef is usually used to make jerky, it may also be made from other meats such as poultry, pork, goat, mutton, lamb or more exotic meat sources. Other types of dried meats are also known such as biltong. Biltong differs from jerky in that it is generally thicker, and the meat is commonly marinated in a vinegar solution before being spiced (e.g., with a mixture of salt and spices) and air dried at a lower temperature than jerky.

The differences in a_{w} values of processed snack food elements create packaging challenges that limit the ability to create unique mixtures of snack elements while maintaining product quality and maximizing shelf life. For example, typical a_{w} values for dried fruit-type trail mix components are usually less than or equal to about 0.60, which is a range that is known to inhibit the growth of not only bacteria, but also yeasts and molds (e.g. Xerophilic molds and osmophilic yeasts). On the other hand, beef jerky could plausibly have a water activity of up to 0.85 a_{w} but is typically at 0.80 (or under). If a mixture of a dried fruit trail mix and beef jerky was manufactured and stored in contact (for example, a 50-50 mixture of the two), the mix would eventually reach an overall water activity somewhere between 0.60 and 0.80, for instance, it could reach a stable water activity value of 0.70 a_{w}. At this intermediate water activity value, the fruit will more easily support growth of yeasts of molds, leading to a shorter shelf life. Additionally, the product quality of the jerky/trail mix combination will be compromised as the migration of moisture will result in drier jerky, and wetter fruit.

### SUMMARY OF THE INVENTION

There are disclosed systems and methods for packaging foods with disparate water activity values. A single consumer package is intended to segregate foods with differing intended a_{w} values, and as such, provide a convenient and safe way for diverse food types to be offered to consumers for purchase. For example, Jerky typically has a higher water activity (a_{w}) than dried fruit & nuts, and in embodiments of the present invention, the jerky is kept separated by virtue of a seal that keeps the two types of ingredients separate, in order to inhibit the movement of water, and resulting in improved shelf life and quality.

As the consumer desires to eat both of these items together in the same pouch, the packaging allows the combining of both ingredients at the time of consumption, reducing the time that both sets of ingredients are in contact with each other, and thereby reducing the ability for water/moisture to transfer between the sets of ingredients.

The two chamber bag can be used to physically separate two ingredients of different water activities, thus inhibiting the movement of water, resulting in improved shelf life and product quality. Dried fruit is typically dried to a water activity of <0.60 a_{w}. At less than 0.6 a_{w}, the dried fruit will not provide sufficient moisture to support the growth of yeasts and molds (Xerophilic molds and osmophilic yeasts).

The present invention relates to the provision of a packaging bag that can be used to keep different foods separate from one another until they are mixed together for consumption which in at least some embodiments, may therefore enhance food quality and/or extend the overall shelf life of the packaged food. However, while at least some embodiments of bags as described herein are suitable for the packaging of foods, the invention is not limited thereto and bags as described herein may also be used for keeping non-food items or materials separate from one another until use.

In particular, in an aspect of the invention there is provided a flexible packaging bag, the bag comprising opposed front and rear panels and having opposite side margins and opposite end regions interconnecting the side margins, and each of the panels has an outside face and an opposite inside face, and the inside faces of the panels are connected together by a join dividing the interior of the bag into side by side compartments, the panels being peelable apart from one another along the join to form a single interior compartment of the bag from the side by side compartments.

Typically, the bag is arranged for being opened at one of the end regions of the bag for access into the interior of the bag.

Typically, the panels of the bag are peelable apart from one another along the join when the one end region of the bag is opened.

Typically, the join is arranged for the panels of the bag to be peeled apart from one another along the join with the opening of the one end region of the bag.

Typically, the bag further comprises a closure system provided at the one end region of the bag, and wherein the closure system is configured for being opened to allow access into the interior of the bag. However, in various embodiments, the bag may or may not be reclosable after being opened.

Hence, in another aspect of the invention there is provided a flexible packaging bag, comprising: opposed front and rear panels, the bag having opposite side margins and opposite end regions interconnecting the side margins; a closure system for closure of the interior of the bag and being provided at one of the end regions of the bag, and each of the panels having an outside face and an opposite inside face; and a join connecting the inside faces of the panels together in the interior of the bag so as to divide the interior of the bag into side by side compartments, the panels of the bag being peelable apart from one another along the join to separate the panels and form a single interior compartment of the bag from the side by side compartments.

Typically, the closure system extends across said end region of the bag from one of the side margins to the other side margin of the bag. Typically, the join is arranged for the panels of the bag to be peeled apart from one another along the join when the closure system is opened.

In another aspect of the invention there is provided a flexible packaging bag, the bag comprising opposed front and rear panels and having opposite side margins and opposite end regions interconnecting the side margins of the bag, one of the opposite side margins and end regions of the bag being respectively joined together to define the interior of the bag, and each of the panels has an outside face and an opposite inside face, and a joining system is arranged to divide the interior of the bag into side by side compartments and for being peeled apart to form a single interior compartment of the bag from the side by side compartments, and wherein one of the side margins or one of the end regions of the bag remains open for allowing access into the interior of the bag, and the one said side margin or end region of the bag is arranged for being closed to seal the interior of the bag.

In another aspect of the invention there is provided a flexible packaging bag, comprising opposed front and rear panels, and having opposite side margins and opposite end regions interconnecting the side margins, and the bag having a closure system extending across one of end regions of the bag from one of the side margins to the other side margin for closure of the interior of the bag, and each of the panels has an outer face and an opposite inside face, and a join connects the inside faces of the panels in the interior of the bag so as to divide the interior of the bag into side by side compartments, the panels of the bag being peelable apart from one another downwardly along the join to form a single interior compartment of the bag from the side by side compartments.

In another aspect of the invention there is provided a method for providing a flexible packaging bag, comprising overlaying sheet material to form front and rear panels of the bag and joining the panels together to form the interior of the bag, and including forming a join in the interior of the bag connecting the front and rear panels of the bag together so as to divide the interior of the bag into side by side compartments, wherein the front and rear panels of the bag are peelable apart from one another along the join to separate the panels to form a single interior compartment of the bag from the side by side compartments.

Typically, the method further comprises forming a closure system to extend across an end region of the bag for closure of the bag and which is openable to permit access into the interior of the bag.

Typically, the join in the interior of a bag embodied by the invention is formed by a peelable seal between the panels of the bag. In at least some forms, the seal comprises a sealant film or strip adhered to the inside face of each of the panels.

In at least some forms, a bag embodied by the invention further comprises a sealed margin extending across the bag on an opposite side of the closure system to the interior of the bag, and the bag is arranged for being cut or torn in a direction across the bag between the sealed margin and the closure system to thereby expose the closure system and so permit opening of the closure system.

A bag embodied by the invention may also comprise a cut-away defined in one of the side margins of the bag and/or a tear guide for guiding tearing or cutting across the bag to expose the closure system to permit the closure system to be opened.

Typically, the closure system of a bag embodied by the invention is a resealable closure system operable to selectively open or close the bag.

Typically, the resealable closure system is adapted for being peeled apart when the bag is opened and progressively press-fitted together across the bag for closure of the bag. Likewise, a slide-zip-type closure may be actuated from an open position to a closed position thereof to affect a seal, in addition to pressing closed a non-slide zip-type closure.

In at least some embodiments, the resealable closure system comprises male and female closure profiles, the male closure profile being disposed on the inside face of one of the panels and the female closure profile being disposed on the inside face of the other of the panels, and the male closure profile is aligned with the female closure profile for press-fit, interlocking engagement with the female profile for closure of the bag.

Typically, the male profile of the resealable closure device comprises at least one rib, and the female profile comprises a channel for inter-locking reception of the rib to hold the bag closed.

In one embodiment, the resealable closure device is in a closed condition. In a preferred embodiment, the resealable closure system is a zipper type closure device. In another aspect of the invention there is provided a flexible and resealable packaging bag, comprising; opposed front and rear panels, and the bag having opposite side margins and opposite end regions interconnecting the side margins; a resealable closure system for selectively opening or closing the bag and which is provided at one of the end regions of the bag; and a peelable seal in the interior of the bag connecting the front and rear panels of the bag together and extending substantially from the resealable closure system to the other said end region of the bag so as to divide the interior of the bag into side by side compartments, the seal being arranged to progressively peel toward the other said end region of the bag to separate the front and rear panels whereby a single interior compartment of the bag is formed from the side by side compartments.

In preferred embodiments, the closure system of a bag embodied by the invention is arranged at a top end region of the bag. A bag in accordance with the invention is particularly suitable for packaging of foods for being mixed together as the front and rear panels of the bag are peeled apart from one another along the join in the interior of the bag immediately prior to consumption of the resulting food mix. In at least some forms the food mix is a “trail mix” for consumption while a person is walking, trekking, hiking, exercising or the like outdoors. Thus, for example, one of the side by side compartments of the bag can contain or be at least partially filled with dried meat pieces (e.g., jerky or biltong) while the other of the compartments can contain or be partially filled with foods commonly used in trail mixes such as one or more of nuts, seed and dried fruit pieces.

Accordingly, in still another embodiment of the invention there is provided a flexible plastic bag comprising opposed front and rear panels, and having opposite side margins and opposite end regions interconnecting the side margins, the bag having a closure system for closure of the interior of the bag and which extends across one of the end regions of the bag from one of the side margins to the other of the side margins, and each of the panels has an outer face and an opposite inside face, the inside faces of the panels being connected together along a join in the interior of the bag so as to divide the interior of the bag into side by side compartments, the panels of the bag being peelable apart from one another along the join to separate the panels to form a single interior compartment of the bag from the side by side compartments, one of the side by side compartments containing dried meat pieces and the other of the side by side compartments containing one or more other edible items.

Advantageously, a closure system in the form of a resealable closure device as described herein allows the bag when used for the packaging of a food, to be opened and closed multiple times until the food contents of the bag have been consumed. That is, the food contents can be partially consumed and the bag re-closed by closure of the resealable closure device until it is wished to consume more of the food on later occasion(s), thus enabling the food to be safely packaged in the bag and “snacked on” over a period of time as required.

Moreover, by retaining one of the foods (e.g., dried meat pieces) in one of the side by side compartments of the bag separate from the food(s) in the other of the compartments until the front and rear panels of the bag are progressively peeled apart in use whereby the join separating the compartments is thereby destroyed allowing the foods in the different compartments to be mixed together, the overall shelf life of the food packaged in the bag may be extended compared to being initially mixed together when first packaged. As well, by separating the foods into the different compartments until use, the quality and/or freshness of the foods overtime may also be enhanced.

The container/bag may be sealed in any desired manner. For example, the bag may be sealed with one heat seal at one side such as a bottom side, or may be sealed by multiple heat seals to the sides, instead, or as well as, the bottom. In various embodiments, a packaging machine may also utilized in concert with aspects of the present invention. Such assembly machine comprises a linear scale, with two separate hoppers for each of the two sets of first and second foodstuff ingredients, which would flow down to two separate scales that weigh and then drop the ingredients into two separate funnels of a pre-determined weight. Then the operator (if semi-automatic) or the machine (when the package is ready) positions the packaging into the two funnels, and operates a button to allow the two sets of ingredients to drop into the package automatically.

In one embodiment, a sealed food product container of the present invention comprises: a first inner compartment and a second inner compartment defined within an interior volume of the container; an opening mechanism to provide access to the contents of the two or more inner compartments; and wherein the first and second inner compartments are sealed and segregated to prevent migration of water from a first provided foodstuff stored within the first compartment to a second provided foodstuff stored within the second compartment. Any diverse values of first and second foodstuffs may be present, and in one aspect, the first a_{w} value of the first foodstuff that exceeds a second a_{w} of the second provided foodstuff. Diverse ranges of foodstuff a_{w} values are envisioned by aspects of the present invention, such as where the first a_{w} is in the range of 0.6 to 0.8, and the second a_{w} is less than or equal to 0.60. In other embodiments, the first a_{w} is in the range of 0.75 to 0.8, and the second a_{w} is less than or equal to 0.75. Various ranges and values of a_{w} may be utilized depending on the types of foodstuffs utilized, for example, the USDA sets an upper limit for nuts at 0.7 a_{w} so that nuts must be below 0.7 a_{w}, in the same way that jerky must be below 0.85 a_{w}. However, in some scenarios, nuts must be well below this, at 0.6 a_{w}.

The foodstuffs may comprise any desired substance, and the first provided foodstuff comprises dried meat pieces, and the second provided foodstuff comprises one or more trail mix components. Additionally, the one or more trail mix components may comprise one or more of nuts, seeds, dried fruit, dried vegetables, chocolate pieces, carob pieces, candy pieces, dried wasabi pieces, and processed or unprocessed grains.

The container may take any desired form for any particular purpose. For example, the container may comprise a flexible packaging bag, the bag comprising: opposed front and rear panels and having opposite side margins and opposite end regions interconnecting the side margins, each of the panels having a respective outside face and a respective opposite inside face, wherein: the respective inside faces of the panels are connected together by a join dividing the interior of the bag into side by side compartments comprising the respective first and second compartments; the panels are configured to be peelable apart from one another along the join to form a single interior compartment of the bag from the first and second side-by-side compartments. The opening mechanism may comprise one of: a resealable zip-type closure, a slide-zip-type closure, an adhesive material that may be opened through peeling apart at least a portion of the front and rear panels, a destructive tear-through panel; and an adhesive material with residual tack that allows for reclosure after initial opening by a consumer. Also, the bag may be configured to be opened at one of the end regions of the bag for access into an interior space interior of the bag, and a gusset may be disposed proximal to one of a side margin or a bottom end region of the bag. The join may comprise one of a perforation and a frangible material allowing for the bag to be separated into at least two components by the consumer, each of the respective two components comprising one of the first and second interior spaces. And the bag may be provided with a scoring allowing for foldability along an axis perpendicular to the major long axis, the foldable area proximate the join. Any desired number of interior compartments may be used, for example, embodiments may include a third or fourth inner compartment defined within an interior volume of the container.

The join inside the bag may comprise any desired attachment type, such as one of a resealable zip-type closure, an adhesive material that may be opened through peeling apart at least a portion of the front and rear panels, a destructive tear-through frangible seal; and an adhesive material with residual tack that allows for reclosure after initial opening by a consumer. The bag may comprise two or more joins disposed in an essentially parallel manner within an interior volume of the bag so that when the bag is opened by a consumer, the two or more joins will separate and provide access to all foodstuff contents within any compartment of the bag, and the bag may have two or more joins disposed in an intersecting manner, the intersection of the joins being one of orthogonal or non-orthogonal crossing, the joins disposed within an interior volume of the bag so that when the bag is opened by a consumer, the two or more joins will separate and provide access to all foodstuff contents within any compartment of the bag.

The container may also comprise other types of packages other than a bag. In one embodiment, the container comprises a first cylinder and a second cylinder each respectively having an open end and a closed end thereof; the first cylinder having an interior diameter greater than an exterior diameter of the second cylinder; the second cylinder having an exteriorly oriented flange proximate the open end of the second cylinder and a seal applied thereto; the open end of the second cylinder disposed within at least one edge of the open end of the first cylinder proximate a tearing abutment disposed on an interior surface of the first cylinder proximate its open end; whereby the central axis of the first cylinder and second cylinder are substantially aligned, forming the first interior compartment within the first cylinder, and the second interior compartment within the second cylinder; wherein the first cylinder and second cylinder disposed to be moved with respect to one another, whereby applying a force moving the closed ends of the first and second cylinders in a direction approaching one another results in a rupture of the membrane.

In another embodiment, a method is provided for fabricating a sealed food product container with provided foodstuffs, the method comprising: selecting a sheet material for fabrication of a flexible packaging bag; affixing a provided closure device to a first layer of the sheet material; applying one of a sealant film and an adhesive to the sheet material for forming a removable join that is to be disposed within two or more segregated interior compartments of the flexible packaging bag, the join disposed as to prevent water migration between the respective interior compartments before the bag is opened by a consumer; overlaying a second layer of the sheet material on top of the first layer to form an opposite panel of the bag; affixing the second layer of the sheet material to the closure device and the one of the sealant film and adhesive, thereby forming the join to create a consumer-removable seal between the first and second interior compartments, the join to be removable by the consumer to allow contents between the first and second interior compartments to be merged; creating the first and second interior spaces having respective loading openings; filling the respective first and second interior spaces with respective first and second provided foodstuffs, by respectively passing the foodstuffs through the respective loading openings, the respective first and second foodstuffs having disparate a_{w} values; and sealing the loading openings to form a sealed end region of the bag.

Creating the first and second interior space having respective loading openings may be accomplished in any manner, such as forming respective opposite side margins by sealing together the first layer and second layers of the sheet material to form a top side margin and opposed peripheral side margins, thereby creating the first and second interior spaces having respective loading openings proximate a bottom end region. Creating the first and second interior spaces having respective loading openings may also comprise forming respective opposite side margins by sealing together the first layer and second layers of the sheet material to form a an opening margin and opposed sealed margins, thereby creating the first and second interior spaces having respective loading openings respectively proximate to side margins of the bag. The sealing of the first layer and second layer may be provided by one of a heat seal and a seal created by an interposing adhesive; and the sealing of the first and second compartments is provided by one of a heat seal and a seal created by an interposing adhesive. Likewise, in certain embodiments, the closure device comprises one of: a resealable zip-type closure; and an adhesive material with residual tack that allows for reclosure after initial opening by the consumer.

As mentioned above, in any aspect of the invention, the first provided foodstuff comprises dried meat pieces, and the second provided foodstuff comprises one or more trail mix components, and such components may comprise one or more of nuts, seeds, dried fruit, dried vegetables, chocolate pieces, carob pieces, candy pieces, dried wasabi pieces, and processed or unprocessed grains.

A gusset may be included in the container such as disposed proximal to one of a side margin or a bottom end region of the bag. In certain embodiments, the join may comprise one of a perforation and a frangible material allowing for the bag to be separated into at least two components by the consumer, each of the respective two components comprising one of the first and second interior spaces, and in some aspects, the bag is provided with a scoring allowing for foldability along an axis perpendicular to the major long axis, the foldable area proximate the join. Further, in some methods, forming respective opposite side margins may be accomplished by sealing together the first layer and second layers of the sheet material to form a top side margin and opposed peripheral side margins, thereby creating the first and second interior spaces having respective loading openings.

A machine mechanism may be used in concert with methods of the present invention; more specifically including coupling provided first and second hoppers respectively holding the first and second foodstuffs to two scales; respectively weighing, through the coupled scales, predetermined respective packing weights the first and second foodstuffs; respectively dispensing the first and second foodstuffs into two funnels respectively coupled to the scales, the funnels disposed so as to align the respective outputs of the funnels with respective openings in the container; dispensing the first and second foodstuffs respectively into first and second interior spaces of the container; and sealing the openings in the container.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers, integers or steps.

Any discussion of documents, acts, materials, devices, articles or the like that has been included in this specification is solely for the purpose of providing a context for the invention. It is not to be taken as an admission that any or all of these matters form part of the prior art base or were common general knowledge in the field relevant to the invention as it existed in anywhere before the priority date of this application.

The features and advantages of the present invention will become further apparent from the following detailed description of exemplary embodiments of the invention together with the accompanying drawings. Both the foregoing summary and the following detailed description are exemplary and explanatory only and are not restrictive of the invention as claimed.

### BRIEF DESCRIPTION OF THE DRAWINGS

A more complete understanding of the present invention may be derived by referring to the detailed description and claims when considered in connection with the following illustrative figures.

FIG. 1 is a diagrammatic front view of a flexible food packaging bag embodied by the invention;

FIG. 2 is a diagrammatic transverse cross-sectional view of a closure system of the bag of FIG. 1 for being opened to permit access into the interior of the bag;

FIG. 3 is a diagrammatic view illustrating the removal of a sealed top section of the bag of FIG. 1 to expose the closure system of FIG. 2;

FIG. 4 is a diagrammatic perspective view of the bag of FIG. 1 being partially opened;

FIG. 5 is a diagrammatic view of the bag of FIG. 4 in an opened condition;

FIG. 6 is a diagrammatic front view of a further bag embodied by the invention;

FIG. 7 is a diagrammatic front view of yet another bag embodied by the invention;

FIG. 8 is a diagrammatic front view of still another bag embodied by the invention; and

FIG. 9 is a diagrammatic front view of yet still another bag embodied by the invention.

FIG. 10 is a diagrammatic front view of yet still another bag embodied by the invention.

FIG. 10A is a diagrammatic front view of yet still another bag embodied by the invention illustrating an included gusset.

FIG. 10A1 is a diagrammatic front view of yet still another bag embodied by the invention.

FIG. 10B is a diagrammatic front view of yet still another bag embodied by the invention.

FIG. 10C diagrammatic transverse cross-sectional view of a closure system of the bag of FIG. 10B as viewed through B for being opened to permit access into the interior of the bag.

FIG. 10D is a diagrammatic front view of yet still another bag embodied by the invention.

FIG. 11 is a diagrammatic front view of yet still another bag embodied by the invention.

FIG. 12 is a diagrammatic front view of yet still another bag embodied by the invention.

FIG. 13 is a diagrammatic front view of yet still another bag embodied by the invention.

FIG. 14 is a diagrammatic front view of yet still another bag embodied by the invention.

FIG. 15 is a diagrammatic front view of yet still another bag embodied by the invention.

FIG. 16 is a diagrammatic front view of yet still another bag embodied by the invention.

FIG. 17 is a diagrammatic front view of yet still another bag embodied by the invention.

FIG. 18 is a diagrammatic front view of yet still another bag embodied by the invention with an exploded section showing the cross sectional view of the gusset with interposing seal.

FIG. 19 is a diagrammatic front view of yet still another bag embodied by the invention.

FIG. 20 is a diagrammatic front view of yet still another bag embodied by the invention.

FIG. 21 is a diagrammatic front view of yet still another bag embodied by the invention.

FIG. 22 is a diagrammatic front view of yet still another bag embodied by the invention.

FIG. 23 is a diagrammatic front view of yet still another bag embodied by the invention.

FIG. 24 is a diagrammatic front view of yet still another bag embodied by the invention.

FIGS. 25A-B are diagrammatic front views of yet still another bag embodied by the invention.

FIGS. 26A-B are respective elevated views and end-on views through point C of yet still another bag embodied by the invention.

FIG. 26C-D is a diagrammatic front view of yet still another bag embodied by the invention.

FIG. 27 is a side elevation view of a cylindrical container of the present invention.

FIG. 28 is a cross sectional view of unconnected elements of the cylindrical container of the present invention.

FIG. 29 is a cross sectional view of the assembled container as shown in FIG. 27, showing a pre-membrane rupture and post-membrane rupture condition.

### DETAILED DESCRIPTION OF EXEMPLARY EMBODIMENTS

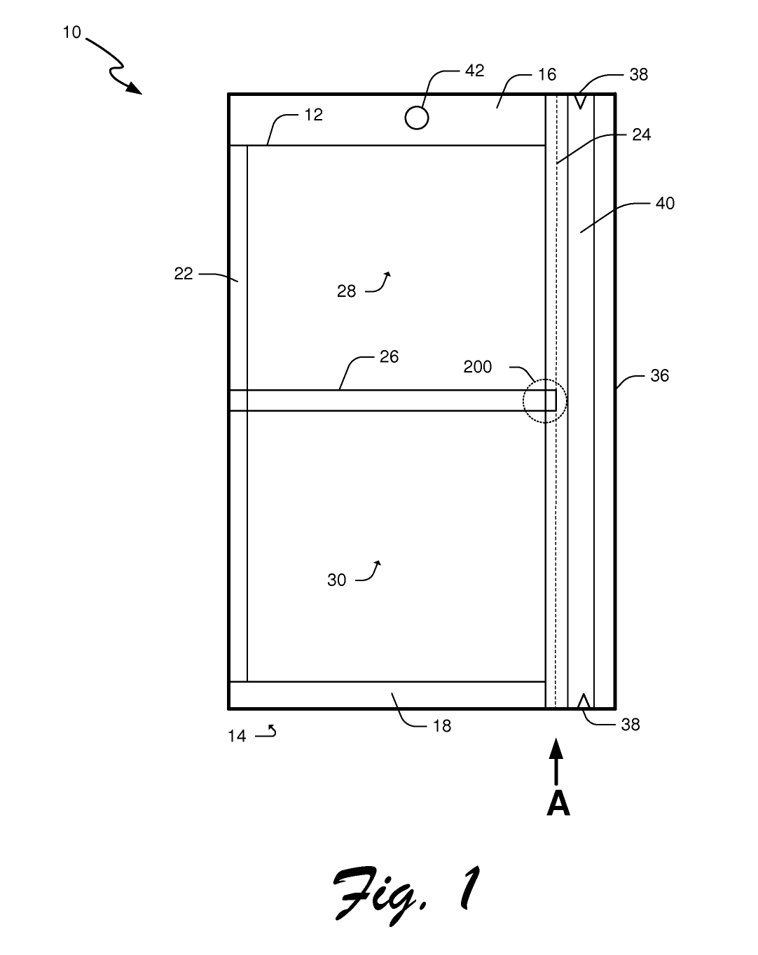

A plastic bag 10 embodied by the invention is illustrated in FIG. 1. The bag comprises front and rear panels 12 and 14 joined together along opposite side margins 16 and 18 that are interconnected by opposite top and bottom end regions 20 and 22. A sealing closure system in the form of a resealable closure device 24 extends across the top region of the bag from one of the side margins 16 to the other side margin 18. As also shown, a peelable join 26 connecting the inner faces of the front and rear panels together is formed in the interior of the bag generally midway between the opposite end margins 12 and 14, and extends in a direction away from the resealable closure device 24 thereby defining side by side interior compartments 28 and 30 of the bag.

In the embodiment shown, the join 26 extends substantially from the resealable closure device 24 to the bottom end region 22 of the bag. While in some embodiments it is desirable that the join 26 seals and isolates the side by side compartments 28 and 30 from one another, in various embodiments it may be desirable that the join does not extend all the way from the resealable closure device 24 to the bottom end region. That is, the bag manufacturing process may produce in a small gap between the join 26 and the resealable closure device 24 and/or the bottom region of the bag 22. The gap may, for example, be of a length of up to 0.75 cm or more, although it is preferred that any such gap be minimized so as to be about 0.5 cm or less (e.g., 4 mm, 3 mm, 2 mm or 1 mm or less). In preferred embodiments, the join will extend completely to the lower region of the bag whereby the bottom of the side by side compartments 28 and 30 are entirely separated from each other by the join.

The peelable join 26 is formed with the use of a commercially available sealant film which adheres to the inner faces of the front and rear panels 12 and 14 of the bag to connect them together until the bag is opened as described further below. The film can be coated on its opposite contact faces with a suitable adhesive and/or for example, become tacky for holding the panels of the bag during the manufacturing process by the application of heat to the film. Commercially available sealant films which may be utilised in the manufacture of a bag embodied by the invention include Easy Peel™ films (J-Film Corporation, Japan) such as VMX™, LCX™ and SMX™ films. Other suitable films that may be utilised include Lami-Tack™ film (J-Film Corporation, Japan) coated with a polyolefin resin. In other forms, the peelable join 26 may be formed by applying a suitable adhesive directly to the inner face of one of front and rear panels prior to overlaying the other of the panels into contact with the adhesive. Adhesives that could be utilised in this embodiment may include Toppyl™ resins (poybutene-1 based resins) such as Toppyl™ SP200B, Toppyl™ SP2001B and Toppyl™ C grade resins (LyondellBasell Industries, Houston Tex., USA).

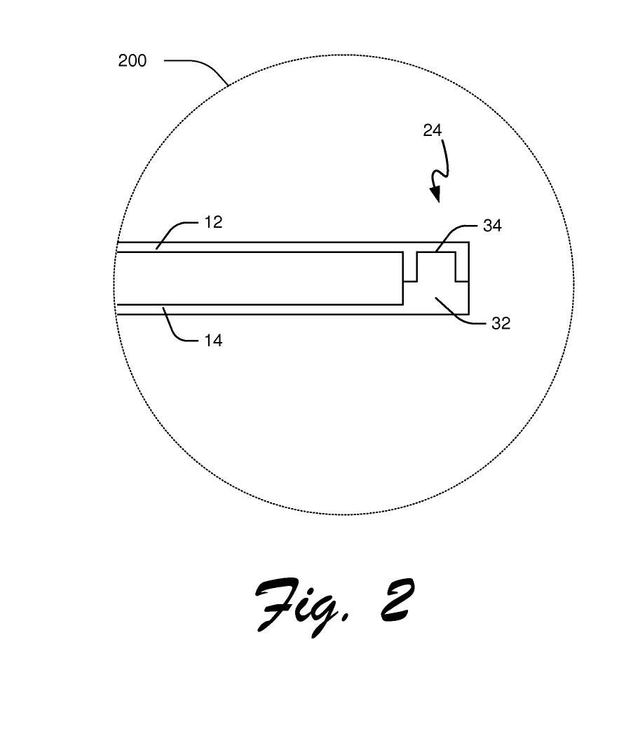

The resealable closure device 24 is a zipper type closure system comprising male and female closure profiles provided on the inner faces of the front and rear panels 12 and 14 of the bag as better shown in FIG. 2. More particularly, in the illustrated embodiment, the male closure profile comprises a protruding rib 32 on one of the panels and which extends the entire width of the bag from one side margin 16 to the other side margin 18. The female closure profile likewise extends the full width of the bag and provides a channel 34 across the other of the panels. The male closure profile is aligned with the female closure profile for press-fit, interlocking engagement of the rib 32 in the channel 34 of the female profile to effect sealing closure of the bag.

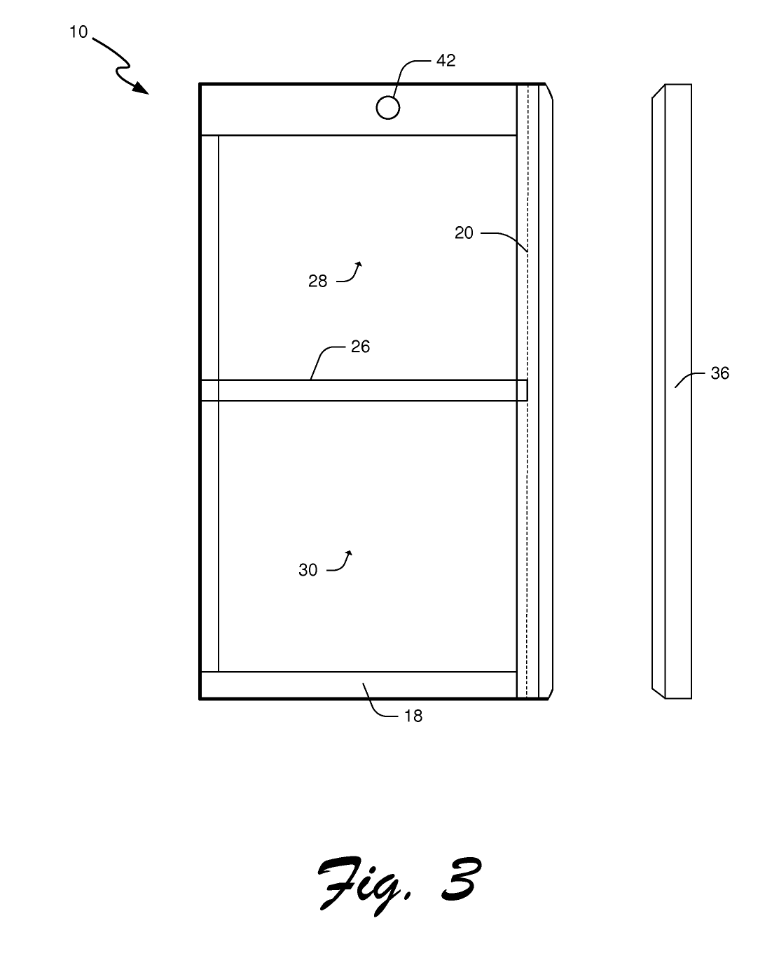

As further shown in FIG. 1, the bag 10 also has a sealed margin in the form of tear away strip 36 above the resealable closure device 24. As can also be seen, a respective cut-away notch 38 is defined in the outer edge of each of the side margins 16 and 18 to facilitate cutting or tearing of the bag to remove the sealed strip 36 and expose the resealable closure device 24 to permit opening of the bag. Each of the cut-away notches is aligned with a section 40 of the bag between the sealed strip 36 and resealable closure device 24 in which the front and rear panels 12 and 14 of the bag are not affixed to one another. Thus, as shown in FIG. 3, once the sealed strip 36 has been removed by cutting or tearing across section 40 of the bag 10, the bag can then be opened. In other embodiments, the sealed strip 36 is not completely removed from the bag during the opening process, making disposal of the bag easier for the consumer. While not shown, a bag embodied by the invention may also be provided with a cutting or tear guide for guiding the cutting or tearing across the bag. The guide may, for instance, comprise thickening external spaced apart ribs or thickenings in the sheet material in which the bag is formed that extend from one of the side margins 16 or 18 of the bag to the other of the side margins, each cut-away 38 being defined between the spaced apart ribs or thickenings.

To open the resealable closure device 24, one only needs to grip the top ends of the front and rear panels of the bag mid-way between the opposite end margins of the bag and to pull the panels part from one another to thereby pull the rib 32 from the channel 34 in that region of the bag. As the panels of the bag are drawn apart from one another the rib is progressively pulled from the channel in each direction across the bag. Such resealable closure devices are conventionally known under the Ziploc™ brand (S.C. Johnson & Son). Various zipper type resealable closure systems and profiles are known in the art and any suitable such system and profiles may be utilised in a bag embodied by the invention.

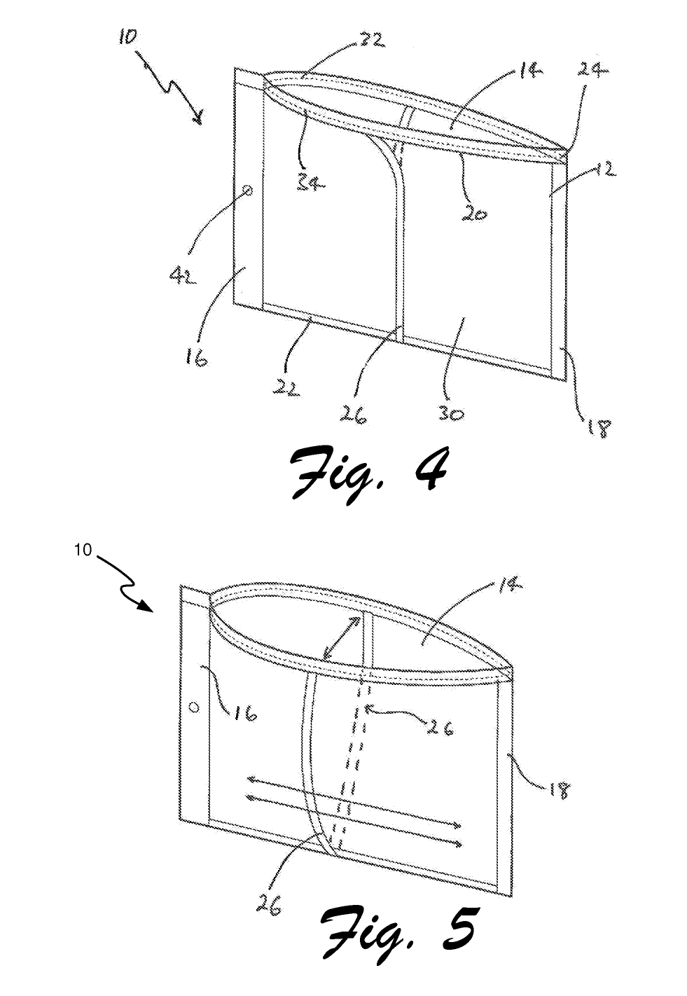

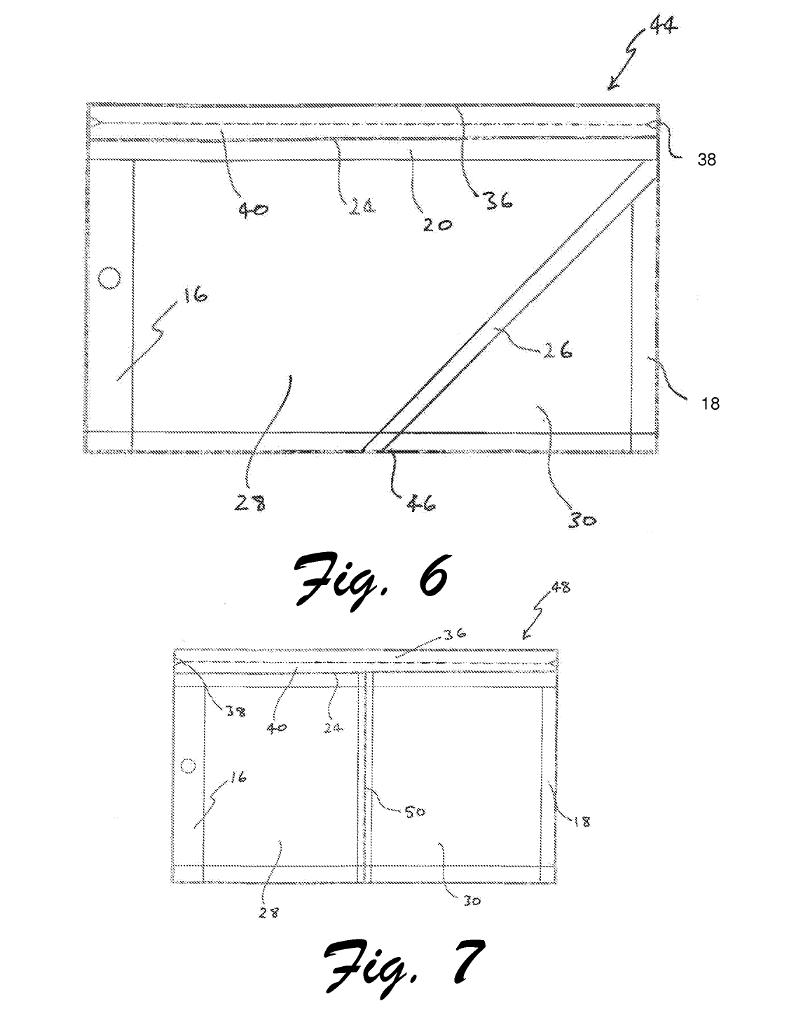

As the interior of the bag 10 is opened by the opening of resealable closure device 24 as described above, the join 26 ruptures and the front and rear panels 12 and 14 of the bag are progressively peeled away from one another downwardly along the join as illustrated in FIGS. 4 and 5 with continued opening of the bag. With the progressive destruction or peeling of the join as the bag is opened, the side by side compartments 28 and 30 of the bag combine together to form a single interior compartment of the bag allowing the contents of those compartments to be mixed together.

A bag 10 embodied by the invention can be used for the packaging of various foods for which it is desired to keep the foods in each of the side by side compartments 28 and 30 of the bag separate until immediately prior to consumption. However, a bag embodied by the invention finds particular application for use in the packaging of a “trail mix” in which one food component of the trail mix is kept separate from the other edible item(s) constituting the trail mix until required until point of consumption. For example, dried meat pieces can be packaged in one of the compartments 28 and 30 of the bag while one or more nuts, seeds, and dried fruits (e.g., sultanas, currants, raisins, cranberries, apricots etc.) and/or other foods commonly included in trail mixes can be packaged in the other one of those compartments. The dried meat pieces will generally be jerky but other dried meats (e.g., biltong), or combinations thereof, may also be used. The jerky or other dried meat pieces can, for example, be beef, lamb, venison, pork, chicken, a more exotic meat such as buffalo, kangaroo, emu, crocodile, camel, and mixtures of the forgoing. As will be understood, once the bag 10 has been opened and the join 26 destroyed by the opening process as described above, the contents of each of compartments 28 and 30 can be mixed together in the interior of the bag as indicated by arrows A in FIG. 5.

Other foods that may be packaged into one of the compartments 28 or 30 of the bag include chocolate pieces or for instance, solid jellies commonly provided with nut mixes or used for confectionary.

A particularly preferred application of a bag embodied by the invention is the separation of wet and dry edible food(s)/item(s) from one another in the side by side compartments of the bag. A yet further application is the separation of a flavouring from a primary food.

To reseal the bag 10, the male and female closure profiles of the resealable closure device 24 are press fitted together at one end between the thumb and forefinger and “zipped” together across the bag by the person drawing their hand across the bag in the conventionally known manner. Slide-type zippers may be also utilized whereby a zipping object engaged with the closure device seals the channels as it is translated from one end of the zipper to another. Thus, a person can initially partially consume the trail mix, reseal the bag, and continue to snack on the trail mix as required at various times while they trekking, hiking, walking or the like until the trail mix is fully consumed or the bag is otherwise discarded.

A bag in accordance with the invention can, for example, be fabricated from a suitable sheet plastics material (e.g., thermoplastic polymers such as low density polypropylene, low density polyethylene (LDPE) and liner low density polypropylene (e.g., LLDPE)) or a foil sheet of the type commonly used in the manufacture of packaging bags for snack foods (e.g., potato crisps). A bag as described herein can also have further front and rear layers to improve the oxygen barrier, appearance and/or durability of the bag. For example, the interior surfaces of the bag can be provided by LLDPE to provide a moisture barrier and which is heat sealable, and each panel of the bag can then have a middle layer of KPET to form an oxygen barrier, and an outer layer of PVDC. Typically, the bag is a disposable plastic bag.

Methods for the manufacture of a bag in accordance with the invention would be apparent to a person of ordinary skill in the art, and any suitable process may be utilised. For example, to provide a bag as described herein, the resealable closure device 24 can be provided as a double-sided adhesive strip in which the male and female closure profiles of the device are press-fitted together, and the strip affixed to the selected sheet material from which the bag is to be fabricated (e.g., LDPE sheet), and applying a sealant film or adhesive to the sheet material for forming join 26, prior to overlaying a further layer of the sheet material on top of the first mentioned sheet to form the opposite panel of the bag, and applying contact pressure to the sheets to affix the adhesive strip providing the resealable closure device to the overlaying sheet and to form the join 26. The opposite side margins 16 and 18 of the bag 10 and the tear away strip 36 may then be formed by heat sealing the top and peripheral side margins of the layers of sheet material together. In an alternate embodiment, the two sides could be filled and then heat sealed rather than the bottom area. This leaves the bottom end of the bag open to enable filling of the side by side compartments 28 and 30 of the bag with jerky or other foods as described above as required, prior to heat sealing the bottom of the bag to form the sealed bottom end region of the final bag.

If needed, the bottom end of the bag can be guillotined or otherwise cut to length to ensure an even length of the front and rear panels 12 and 14 prior to heat sealing of the bottom of the bag. The opposite side margins 16 and 18 of the bag and/or the sealed tear away strip 36 of the bag can also likewise be trimmed. If desired, a hole 42 can also be punched through one of the sealed side margins of the bag to allow the bag product to be slid on to a store shelf peg for sale of the finished product.

Alternatively, rather than heat sealing the respective peripheral side and top of bottom ends of bag as described above, one or more of those may be sealed with the use an adhesive or sealing tape between the overlying layers of sheet material.

In yet other embodiments, sheet webbing in which the male and female profiles of the resealable closure device 24 are integrally formed in the webbing may be formed by an extrusion process from a thermoplastic melt such as described in, for instance European Patent Application No. 1318007. In this instance, the male closure profile can be formed along a face of one end region of the extruded web and the female closure profile formed along an opposite end region of the web, wherein an adhesive or sealing film for formation of the join 26 is applied to the same face of web, prior to the web being folded over on itself whereby the male and female closure profiles are aligned and press-fitted together, and the opposite side margins 16 and 18 and the tear away strip 36 being formed as described above. To fill the side by side compartments 28 and 30 with the respective food(s), the bottom end of the bag can be removed by guillotining or other suitable cutting process to allow each of the compartments to be filled, prior to resealing the bottom end region of the bag by any suitable technique.

Typically, however, a bottom end or side of the bag will normally be left open by the manufacturer of the bag to allow filling of the bag either manually or automatically, prior to sealing of the open end or side, and it will be understood that a bag in accordance with the invention can be manufactured employing any suitable manufacturing technique(s).

While in the bag 10 shown in FIG. 1 to FIG. 5 the peelable join 26 lies perpendicularly with respect to the resealable closure device 24, in other embodiments the join may instead extend downwardly from the resealable closure device 24 to one of the side margins 16 or 18 of the bag and thereby, lie at an oblique angle with respect to the resealable closure device. However, again, the front and rear panels 12 and 14 of the bag of the bag can be progressively peeled away from one another downwardly along the join as the resealable closure device 24 is progressively opened.

A number of further bags embodied by the invention are described below. In the description that follows, at least some like features of those bags are numbered similarly to features of the bag shown in FIG. 1 to FIG. 5 for reasons of ease of description.

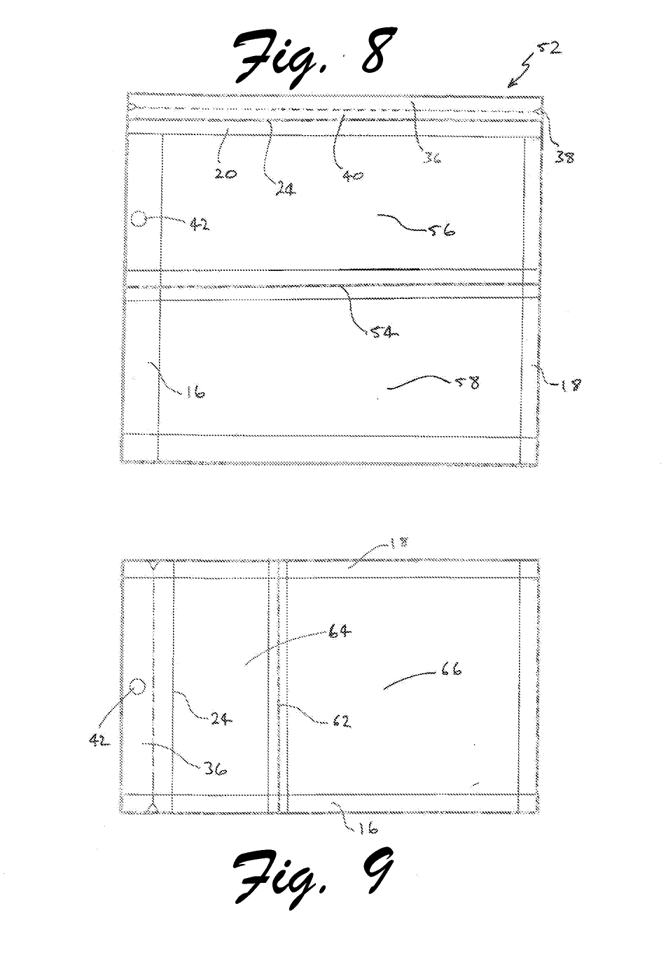

Another disposable plastic bag 44 embodied by the invention is, for example, shown in FIG. 6. In this instance, the join 26 extends from the side margin 18 of the bag downwardly to the bottom 46 of the bag to divide the interior of the bag into side by side compartments 28 and 30. As with the embodiment shown in FIG. 1, the front and rear panels 12 and 14 of the bag can be peeled apart from one another down the length of the joint 26 to allow the contents of the side by side compartments to be mixed together once the resealable closure device 24 has been opened as described above. In this embodiment, the bottom 46 of the bag is left open until the side by side compartments 28 and 30 are filled with the respective food(s) prior to the bottom end region of the bag being heat sealed to close the respective compartments.

It will be understood it is not necessary that the closure system (e.g., resealable closure device 24) for closure of the top end region of a bag embodied by the invention be a zipper type closure system. That is, any other suitable resealable or non-resealable closure system may be utilised. For example, the top region of a bag embodied by the invention may be closed by a peelable join extending from one and margin 16 to the other and margin 18 of the bag and which is formed with the use of a sealant film as described above. In yet other embodiments, the closure system for closure of the top region of the bag may be formed by heat sealing the front and rear panels of the bag together to form a sealed strip for being torn from the bag in use to prior to the front and rear panels of the bag being peeled apart from one another along a join 26.

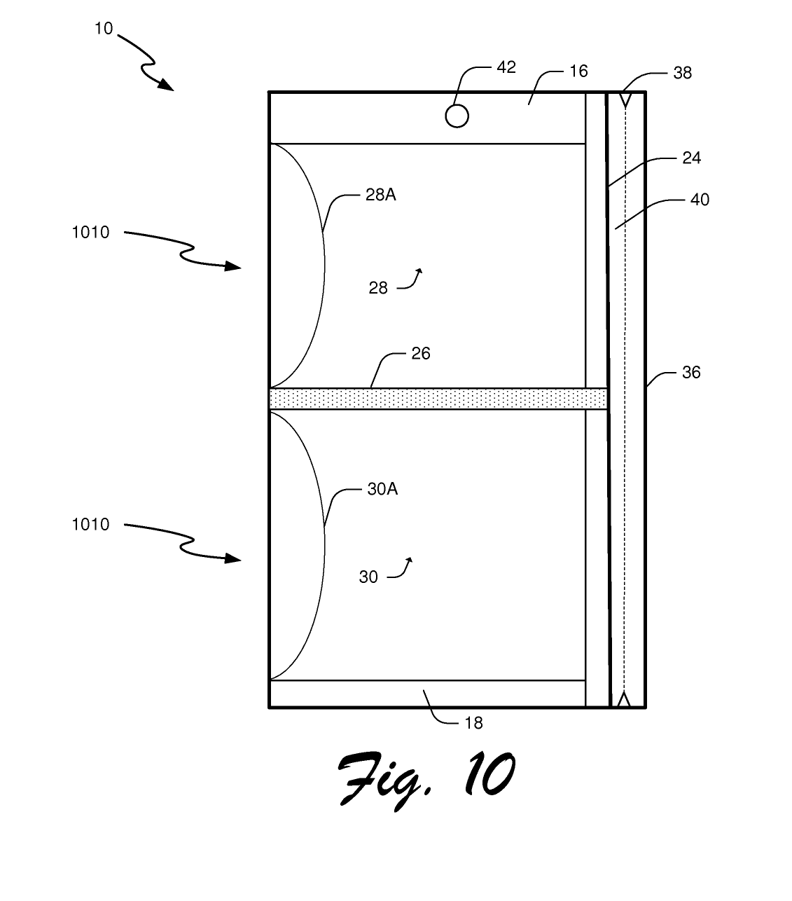

Likewise, the join dividing interior of a bag embodied by the invention into side by side compartments need not be in the form of a sealing strip as described above and other suitable join systems may also be employed. For example, the join can be provided by a join system in the form of a resealable closure device such as a zipper type closure system described above. An example of this type of bag is illustrated in FIG. 7. In this embodiment, the bag 48 has a resealable zipper type closure system closing the top of the bag and a further zipper type closure forming a join 50 dividing the interior of the bag into side by side compartments 28 and 30. To fill the bag, the side margin 16 of the bag is heat sealed and the join 50 is left open to enable compartment 28 to be filled with the relevant food(s) through open side margin 18 of the bag. Once the compartment 28 is sufficiently filled, the join 50 is closed and the other compartment 30 of the bag is then filled with the further food(s) before the side margin 18 is heat sealed. In a variation of this embodiment, the join 50 can be closed and the opposite side margins 16 and 18 of the bag both left open to enable one of the compartments 28 and 30 to be filled with the relevant food before the corresponding side margin 16 or 18 of the bag is heat sealed to close that compartment. The other compartment of the bag can then be filled through the open opposite side margin before that side margin is then heat sealed. In an alternate embodiment, both compartments 28, 30 are loaded with foodstuffs, and afterwards the side margin is heat sealed after both compartments have been loaded.

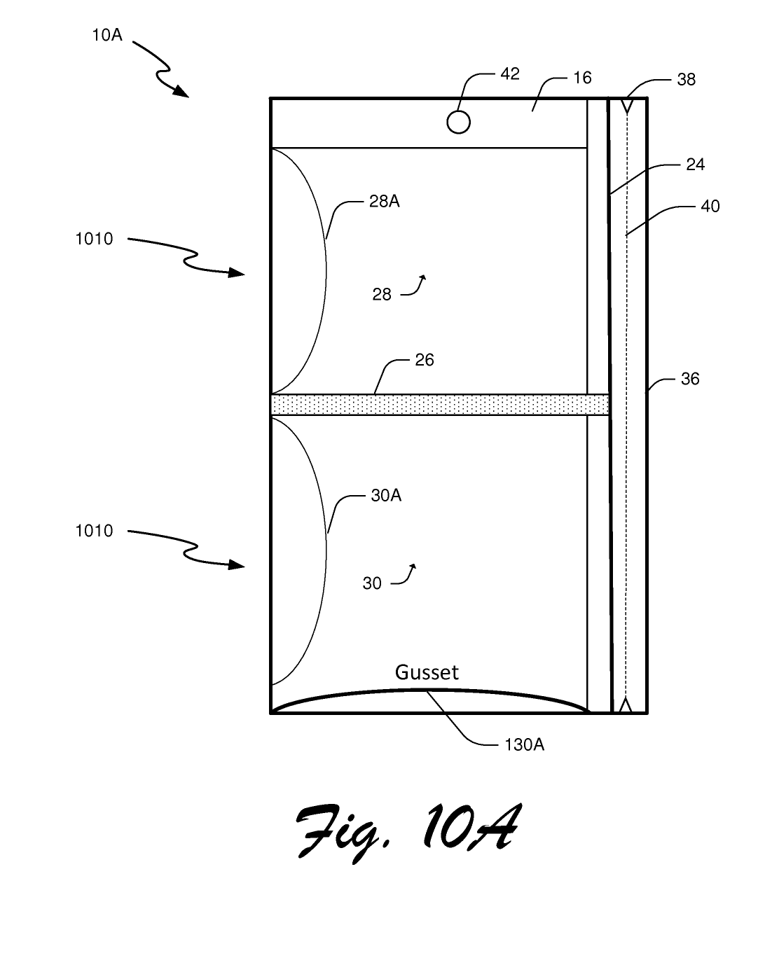

Still another bag 52 embodied by the invention is shown in FIG. 8. This bag has a resealable closure device 24 in the form of a zipper type closure system closing the top end region of the bag as in the embodiment shown in FIG. 1. However, as can be seen, rather than a join 26 extending perpendicularly from the resealable closure device 24 to the bottom end region 22, a join in the form of another resealable zipper type closure device 54 lying parallel to the closure device 24 divides the interior of the bag into top end bottom side by side compartments 56 and 58. To fill this bag, side margin 18 is again left open allowing access to each of compartments 56 and 58 enabling them to be filled with the respective foods prior to side margin 18 being heat sealed to close each of those compartments.

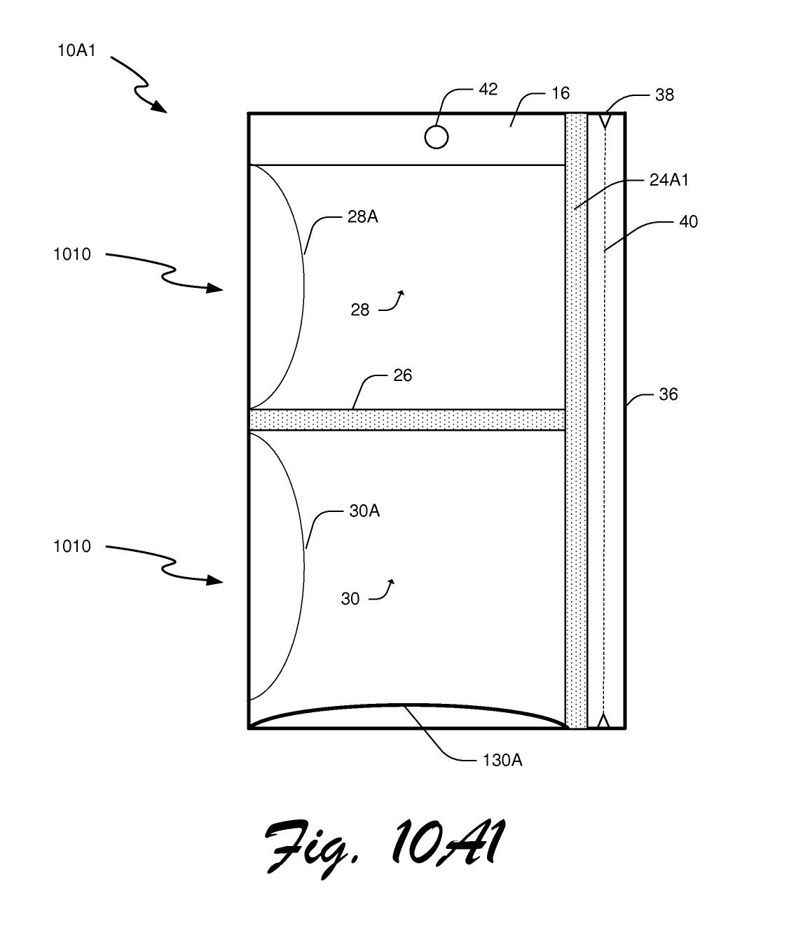

Yet another bag 60 embodied by the invention is shown in FIG. 9. This bag is also provided with parallel closure systems in the form of zipper type closures 24 and 62 each having male and female closure profiles as above described. To fill this bag, the resealable zipper closure 62 is left open to allow filling of compartment 64 with the selected food(s) through the open bottom of the bag prior to the zipper closure 62 being closed, filling of compartment 66, and heat sealing of the bottom of the bag.

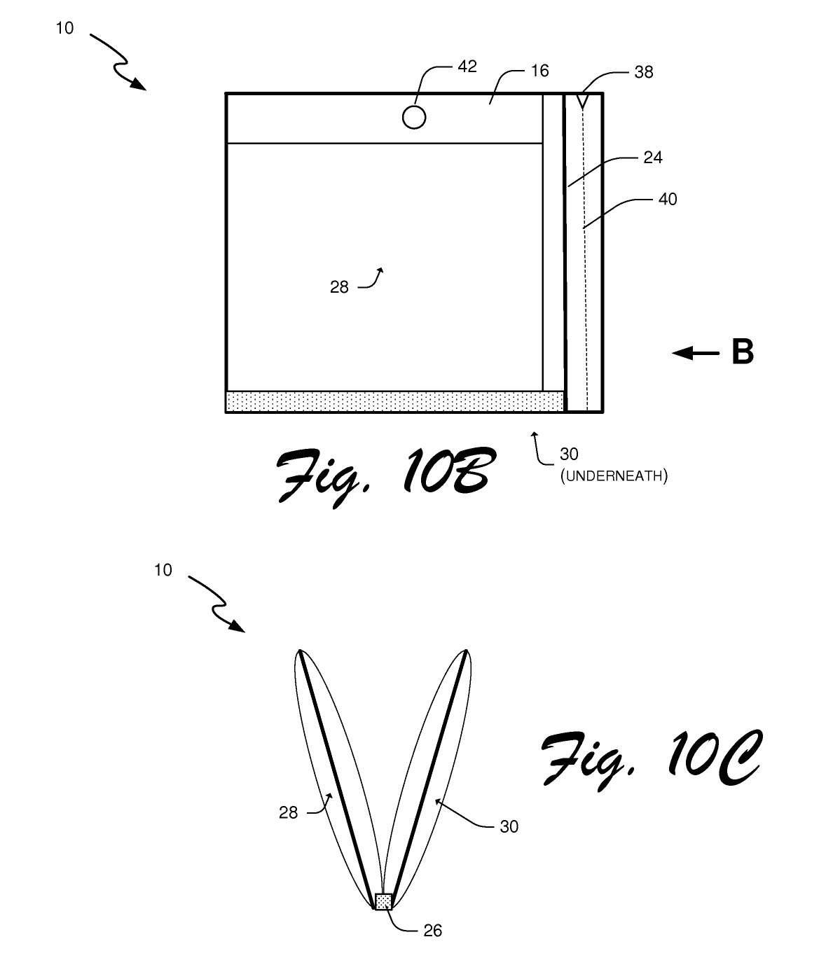

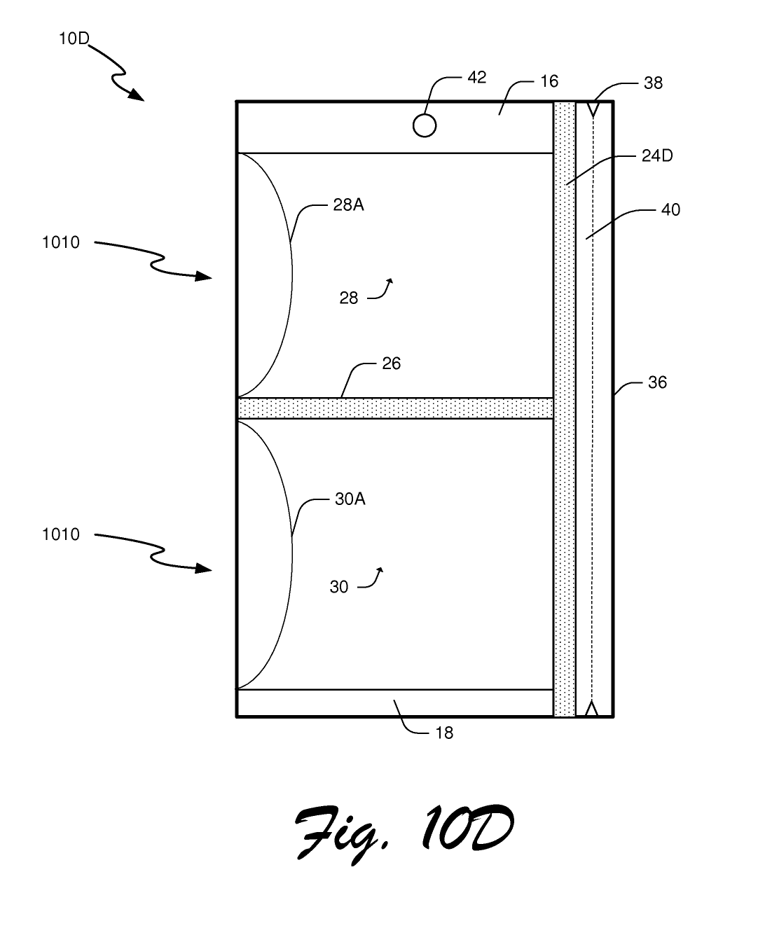

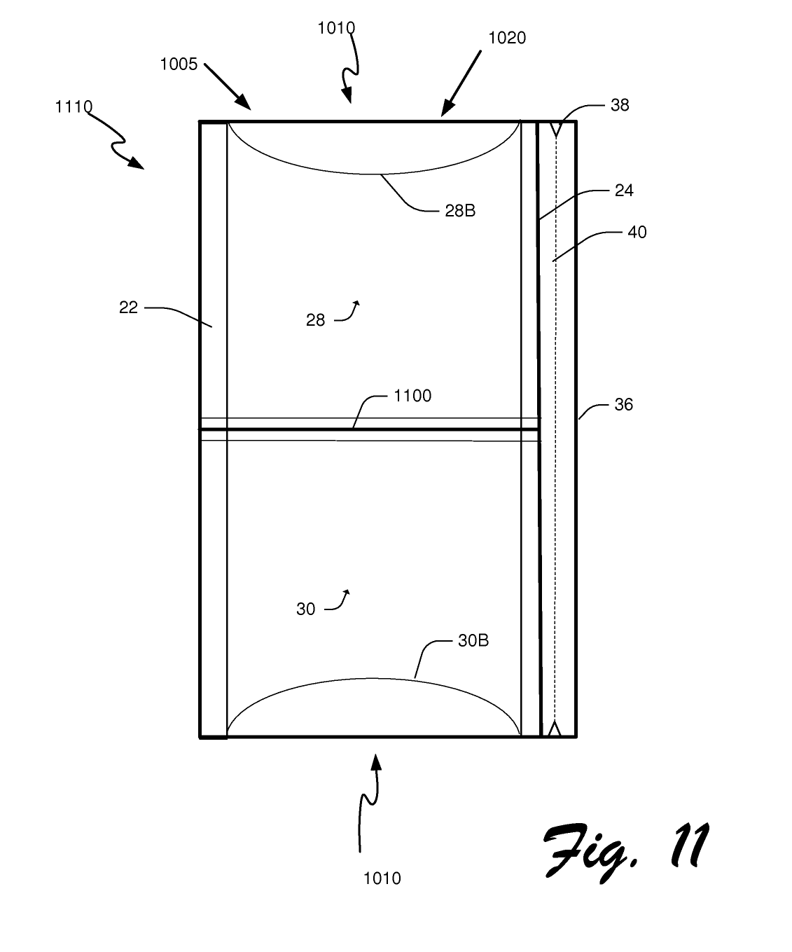

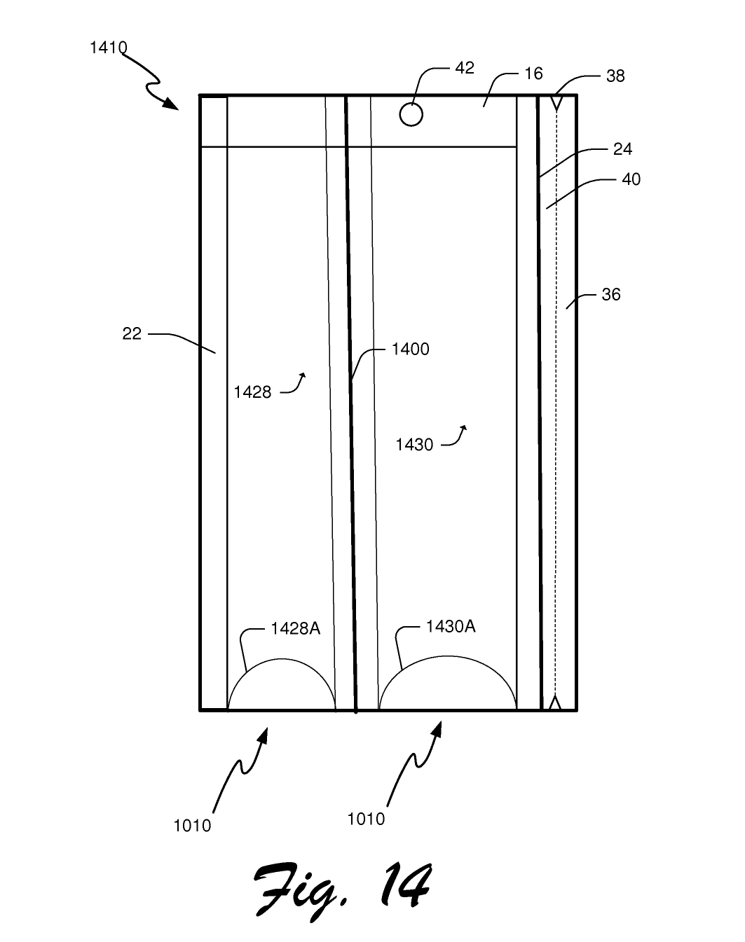

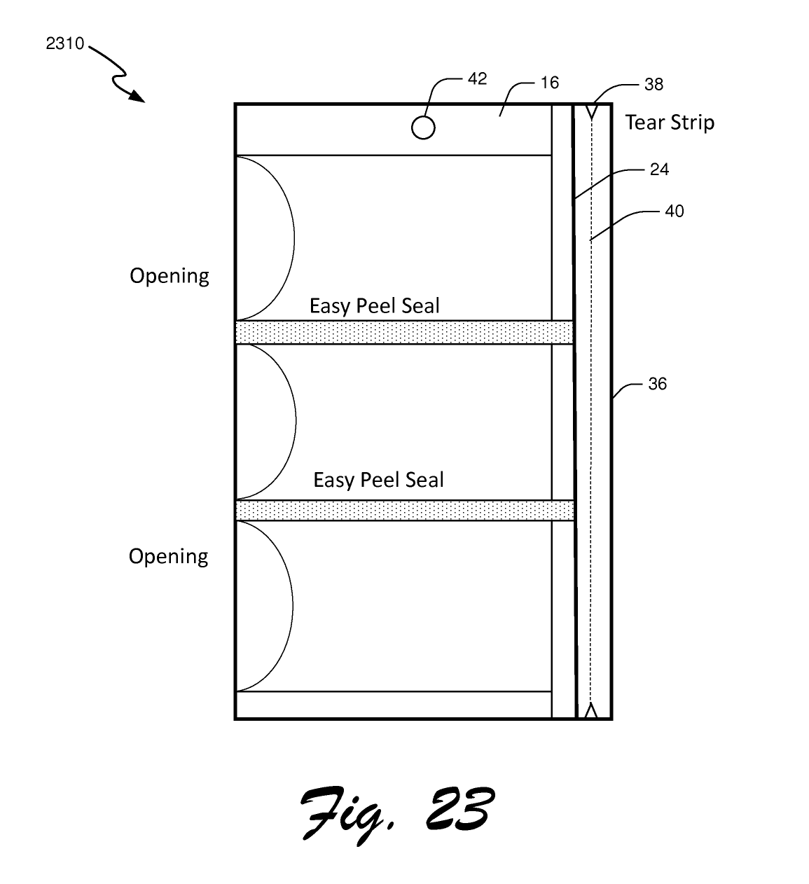

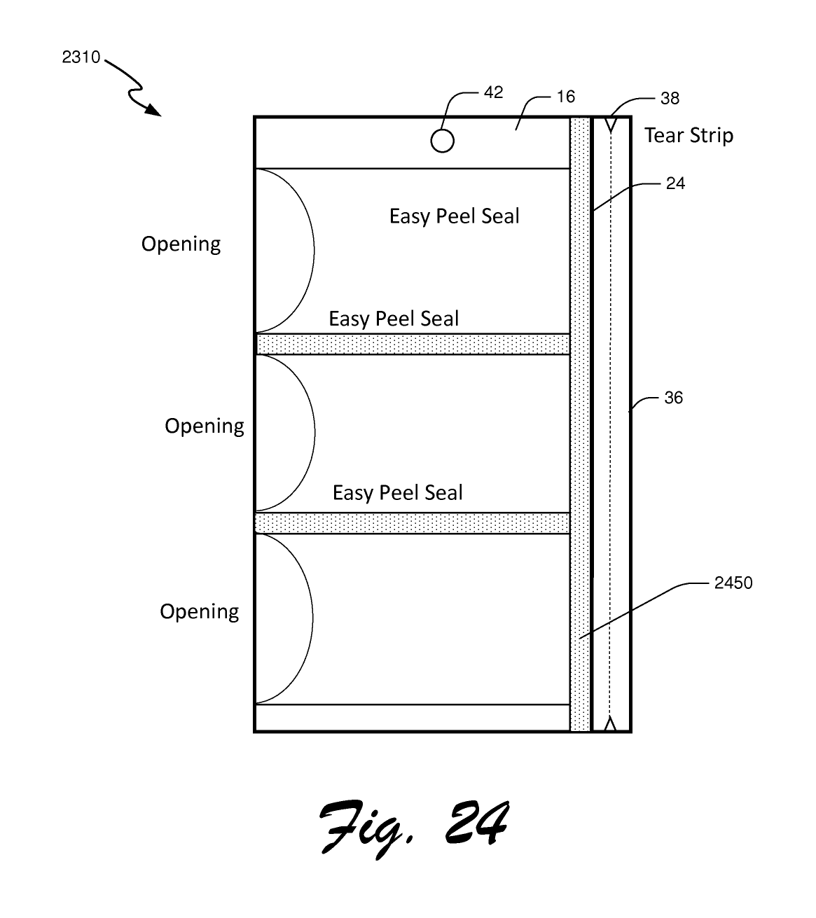

An illustration of an embodiment container/bag 10 along with its fill components are shown in FIG. 10. FIG. 10 depicts container/bag 10, which is formed with a pre-closed side seal zipper 24 added to the right side of pack before filling occurs, as well as a removable peel-seal 26 that segregates the inner compartments 28, 30. Sides 16 and 18 are sealed (such as by a heat seal) as well as the zipper 24, and then compartments 28 and 30 are filled with foodstuffs from the respective compartment openings 28A, 30A. A similar embodiment is shown in FIG. 10D, where instead of a zipper 24, the bag 10D has installed a seal strip 24D, that may comprise an adhesive with residual tack that may offer resealability after the consumer would open the bag 10D. The compartment openings 28A, 30A are then sealed (such as by a heat seal) so that the inner compartments are now completely closed. In one embodiment, the foodstuffs loaded into respective compartments 28 and 30 comprise differing water activity values, and the segregation of the compartments 28 and 30 through seal 26 maintains freshness by preventing water migration between the foodstuffs stored in the respective compartments 28 and 30. In an alternate embodiment shown in FIG. 13, the seal 26 is replaced with a central zip-type middle seal 1100, and final loading and sealing of the compartments 28, 30 takes place similarly. In yet another embodiment (not shown) the seal 26 comprises a frangible seal that is destructively removed as the bag is opened. When the consumer opens the package by removing the tear strip, and unzipping the closure 24, the seal 26 (or zip 1100 for the aspect shown in FIG. 13) opens as well, allowing mixture of the individual foodstuffs previously stored in compartments 28 and 30. As shown in FIG. 10A, a similar embodiment is shown with an added gusset at the bottom area 130A. Among other functions, the gusset may allow the bag to stand vertically on its own when the gusset 130A has been opened from a closed position, and in respects similar to FIG. 10, loading and sealing takes place similarly, except gusset 130A is added at the initial seal and formation of the sheets rather than flat side 18 shown in FIG. 10. In another aspect of the gusseted embodiment of FIG. 10A, similar embodiment is shown in FIG. 10A1, where instead of a zipper 24, the bag 10A1 has installed a seal strip 24A1, that may comprise an adhesive with residual tack that may offer resealability after the consumer would open the bag 10A1. In further similar embodiments, FIGS. 23 and 24 show three-compartment aspects of the present invention, and in FIG. 24, an additional peal seal 2450 is added parallel to the opening 24.

FIGS. 10B and 10C illustrate an additional aspect of the present invention. The container/bag 10 may be folded along its axis that is substantially parallel to the join 26. As FIG. 10C shows from the direction of letter “B” in FIG. 10B, the two compartments 28 and 30 may be folded together to minimize space of the container/bag, and allow for easy storage or carry by the consumer. Alternatively, as scoring mark may be provided to assist with folding the bag along the central join area, and in some embodiments, the package may have a widened seal area and additional punch holes to provide for display in the folded configuration.

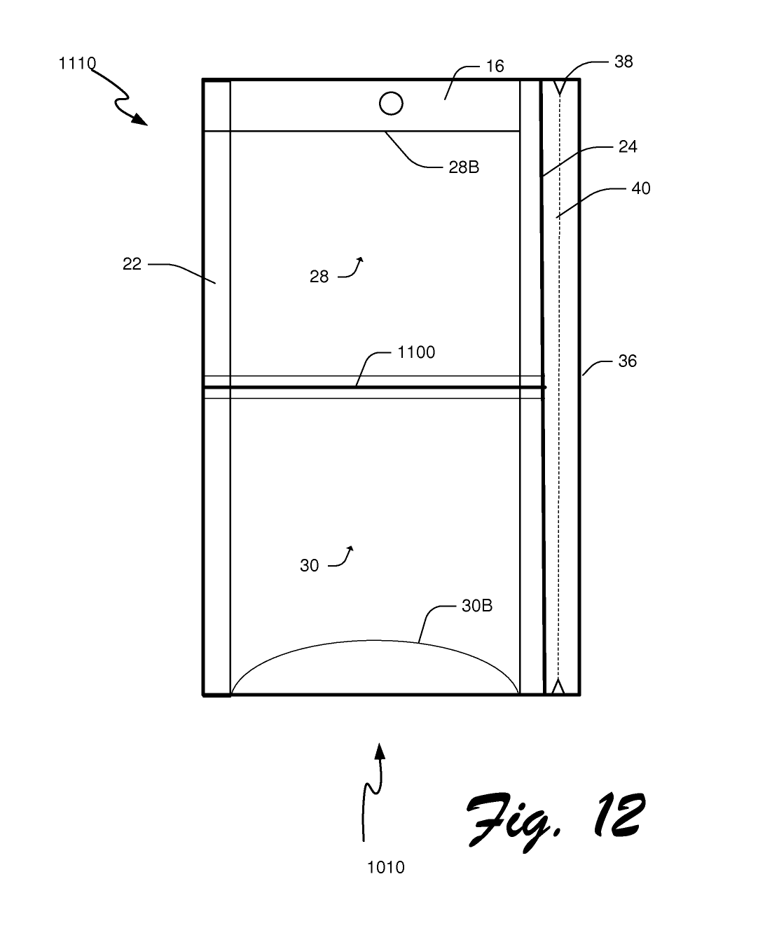

In FIG. 11, container/bag 1110 is formed with a pre-closed side seal zipper 24 added to the right side of pack before filling occurs, as well as a zip-type middle seal 1100. Side 22 is sealed as well as the zipper 24, and then compartments 28 and 30 are filled with foodstuffs from the top and bottom areas 1010 of the respective openings 30B 28B. After loading, top sheet and bottom sheet of the container/bag 1100 proximate the compartment openings 28B, 30B are sealed together, such as by a heat seal, so that the inner compartments 28, 30 are now completely closed. In one embodiment, the foodstuffs loaded into respective compartments 28 and 30 comprise differing water activity values, and the segregation of the compartments 28 and 30 through seal 1100 maintains freshness by preventing water migration between the foodstuffs stored in the respective compartments 28 and 30.

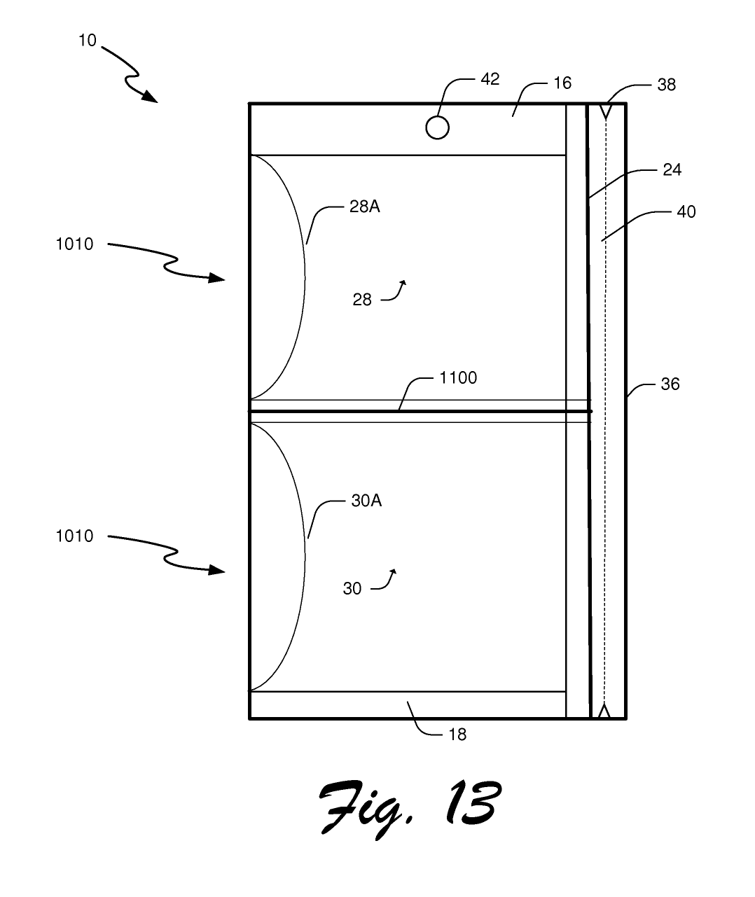

Another embodiment of the present invention is shown in FIG. 12. Container/bag 1110 is formed with a pre-closed side seal zipper 24 added to the right side of pack before filling occurs, as well as a zip-type middle seal 1100. Sides 16 and 22 are sealed as well as the zipper 24, and then the middle seal 1100 is opened to load a first foodstuff through the opening 30B into the top compartment area 28. Once the foodstuff has been loaded into top compartment 28, the zip seal 1100 is closed, such as by application of pressure, and then foodstuff is loaded 1010 into the lower compartment 30 through the opening 30B. After loading, top sheet and bottom sheet of the container/bag 1110 proximate the compartment opening 30B are sealed together, such as by a heat seal, so that the inner compartments 28, 30 are now completely closed. In one embodiment, the foodstuffs loaded into respective compartments 28 and 30 comprise differing water activity values, and the segregation of the compartments 28 and 30 through seal 1100 maintains freshness by preventing water migration between the foodstuffs stored in the respective compartments 28 and 30.

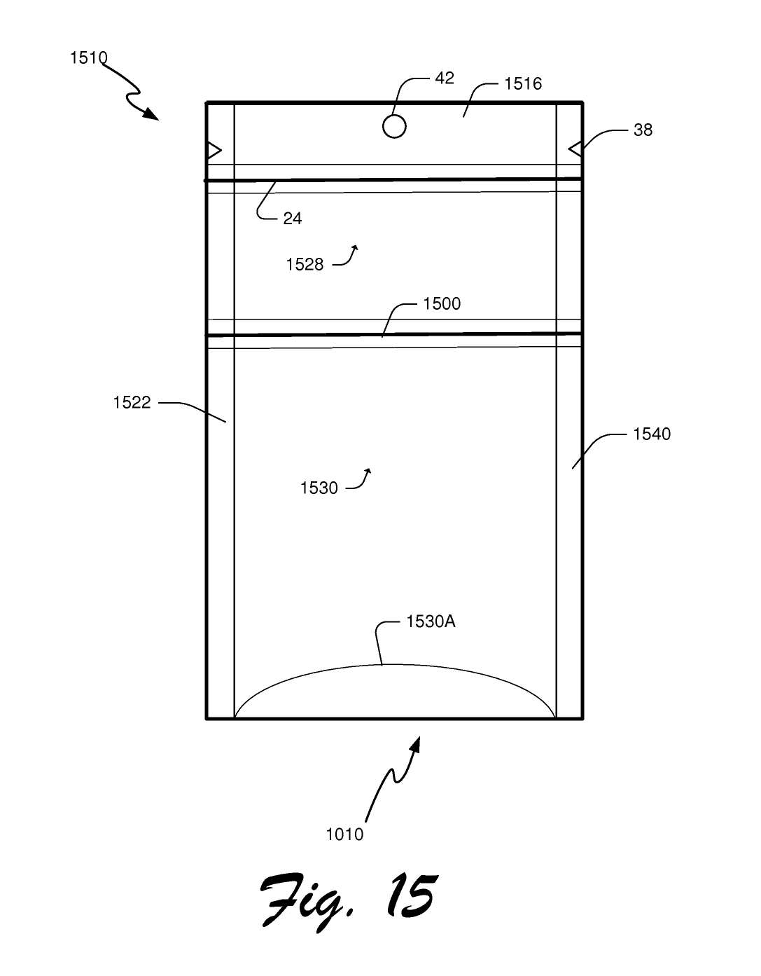

Turning to FIG. 14, an additional embodiment is shown with vertically-arranged compartments 28, 30. Container/bag 1410 is formed with a pre-closed side seal zipper 24 added to the right side of pack before filling occurs, as well as a middle seal 1400. The middle seal 1400 may comprise either a zip-type seal or a peel seal as described previously. Sides 16 and 22 are sealed as well as the zipper 24 and middle seal 1100, and then a first foodstuff is loaded through the opening 1430A into the top compartment area 1430 and a second foodstuff is loaded through the opening 1428A into compartment area 1428. In regards to any of the embodiments of the disclosed invention, those of skill in the relevant arts appreciate that the loading may occur one foodstuff at a time, or both first and second foodstuffs may be loaded in parallel into the respective compartments 1428, 1430 whether manually or by machine. After loading, top sheet and bottom sheet of the container/bag 1400 proximate the compartment openings 1428A, 1430A are sealed together, such as by a heat seal, so that the inner compartments 1428, 1430 are now completely closed. In one embodiment, the foodstuffs loaded into respective compartments 1428 and 1430 comprise differing water activity values, and the segregation of the compartments 1428 and 1430 through seal 1400 maintains freshness by preventing water migration between the foodstuffs stored in the respective compartments 1428 and 1430.

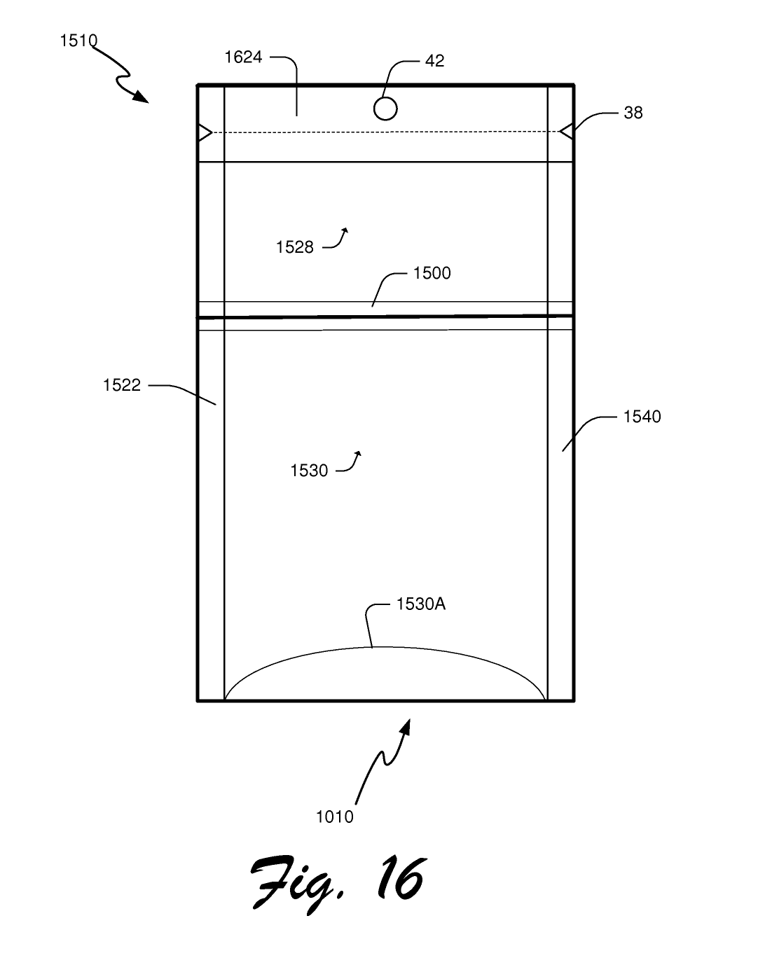

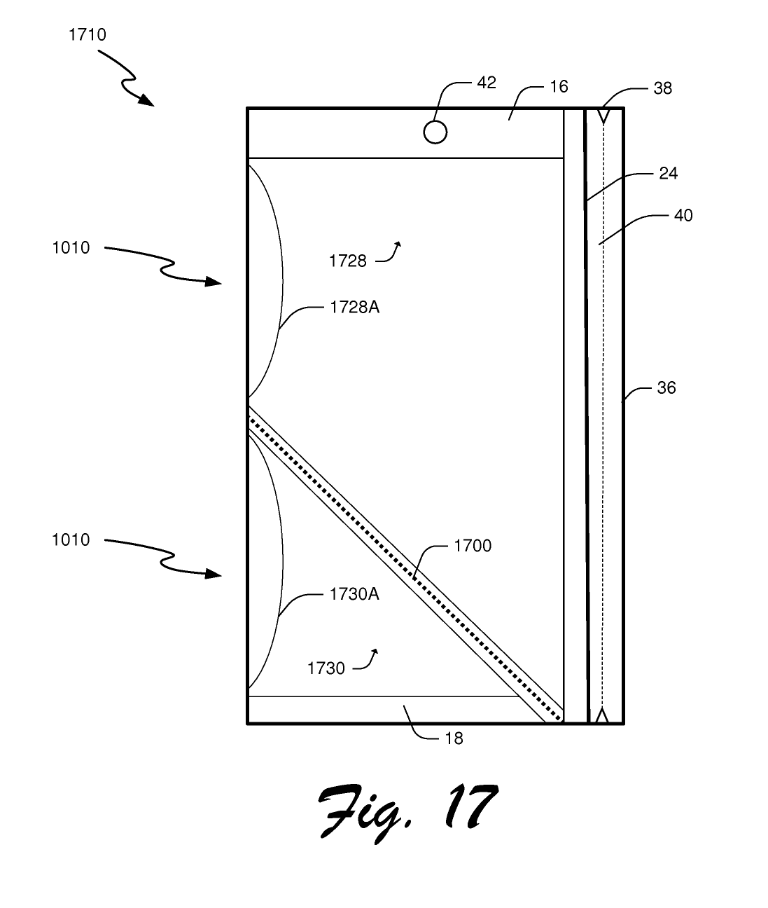

Yet another embodiment is shown in FIG. 15. Container/bag 1510 is formed with a pre-closed top seal zipper 24 added to the top side 1516 of pack before filling occurs, as well as a zip-type middle seal 1500. Sides 1516 and 1522 are sealed as well as the zipper 24, and then the middle seal 1500 is unzipped/opened to load a first foodstuff through the opening 1530 into the top compartment area 1528. Once the foodstuff has been loaded into top compartment 1528, the zip seal 1500 is closed, such as by application of pressure, and then foodstuff is loaded 1010 into the lower compartment 1530 through the opening 1530A. After loading, top sheet and bottom sheet of the container/bag 1510 proximate the compartment opening 1530A are sealed together, such as by a heat seal, so that the inner compartments 1528, 1530 are now completely closed. In one embodiment, the foodstuffs loaded into respective compartments 1528 and 1530 comprise differing water activity values, and the segregation of the compartments 1528 and 1530 through seal 1500 maintains freshness by preventing water migration between the foodstuffs stored in the respective compartments 1528 and 1530. FIG. 16 shows a similar embodiment, but where the top zip-type seal 24 of FIG. 15 is replaced by a heat seal strip 1624, so that removal by tearing through notches 38 creates an opening that may be non-reclosable, although those of skill in the art may appreciate that in one variant, an adhesive may be applied proximate to area 1624 that maintains residual tack so as to allow a reclosing mechanism. Loading and sealing of the bag illustrated in FIG. 16 proceeds similarly to that illustrated in FIG. 15.

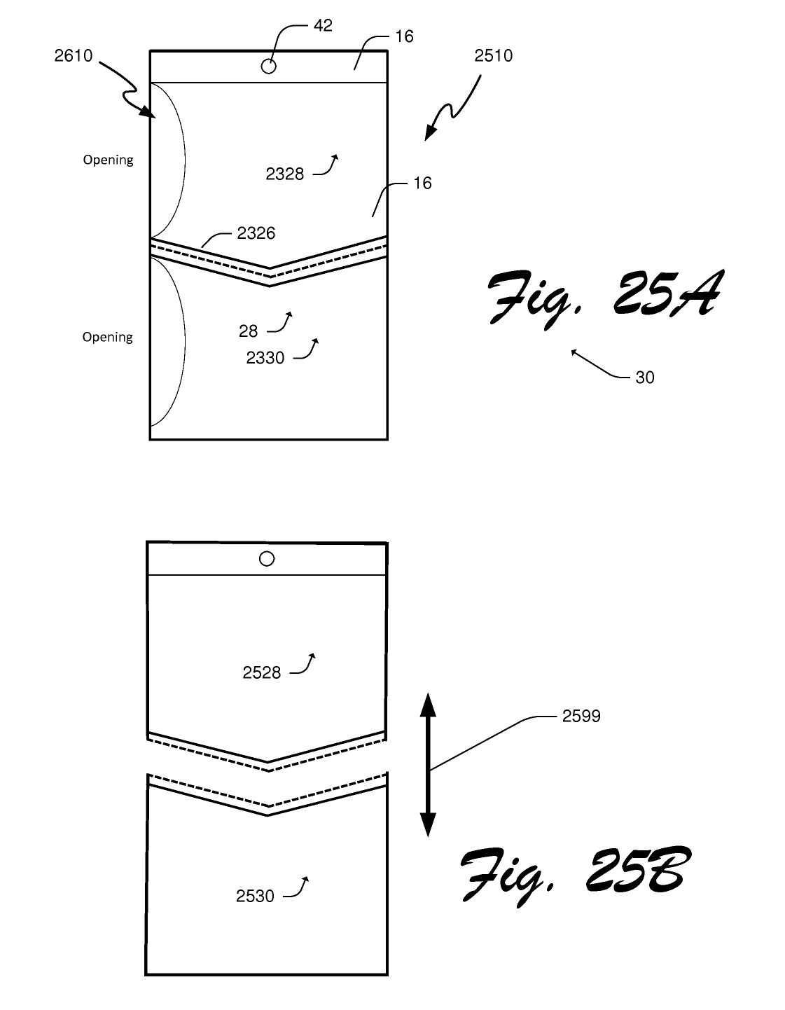

FIG. 17 depicts another embodiment of the present invention with a removable compartment 1730. The container/bag 1710 is formed with a pre-closed zipper 24 added to the right side of the bag before filling occurs, as a sealed area 1700 is added (through a process such as a heat seal) along with a perforation in the sealed region 1700 that segregates the inner compartments 1728, 1730. Sides 16, and 18 are sealed (such as by a heat seal) as well as the zipper 24, and then compartments 1728 and 1730 are filled with foodstuffs from the respective compartment openings 1728A, 1730A. The compartment openings 1728A, 1730A are then sealed (such as by a heat seal) so that the inner compartments are now completely closed. In one embodiment, the foodstuffs loaded into respective compartments 1728 and 1730 comprise differing water activity values, and the segregation of the compartments 1728 and 1730 through sealed area 1700 maintains freshness by preventing water migration between the foodstuffs stored in the respective compartments 28 and 30. In the illustrated embodiment, the consumer may remove the sealed area of the bag through ripping through the perforation in the area 1700. Similarly in FIGS. 25A and 25B, frangible seal 2326 may be separated 2599, resulting in two separate compartments 2328, and 2330. Loading of the bag 2310 proceeds through the illustrated openings, and sealing closes the openings as described herein.

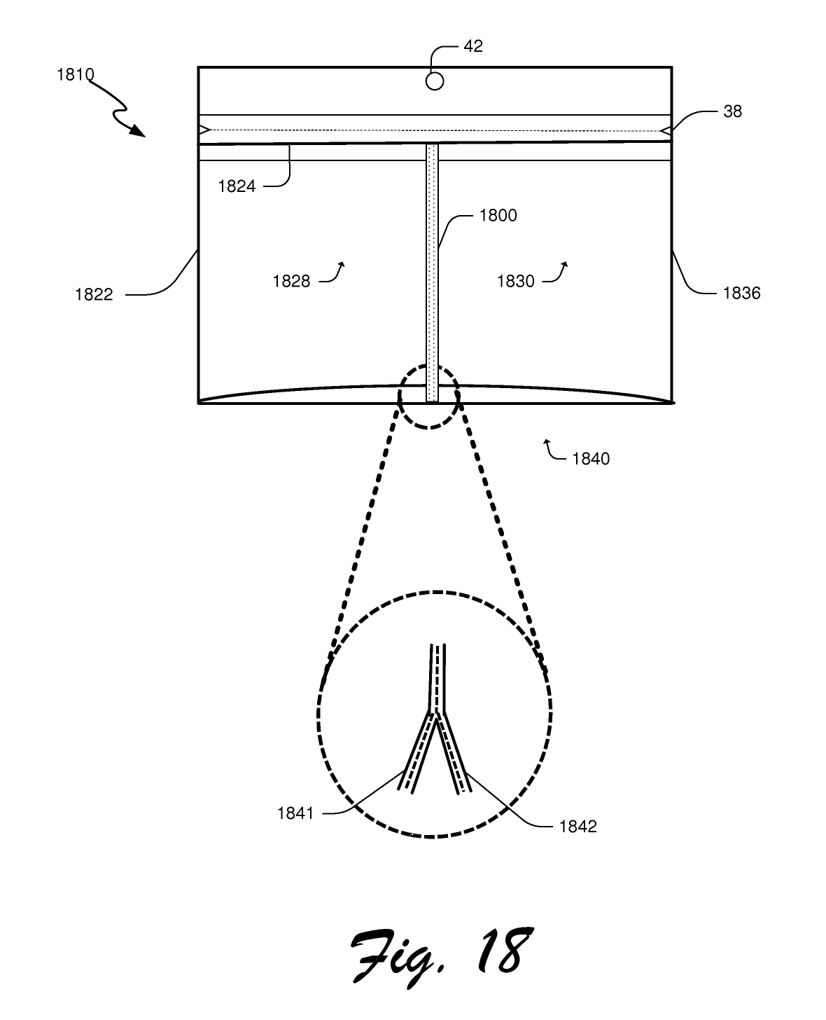

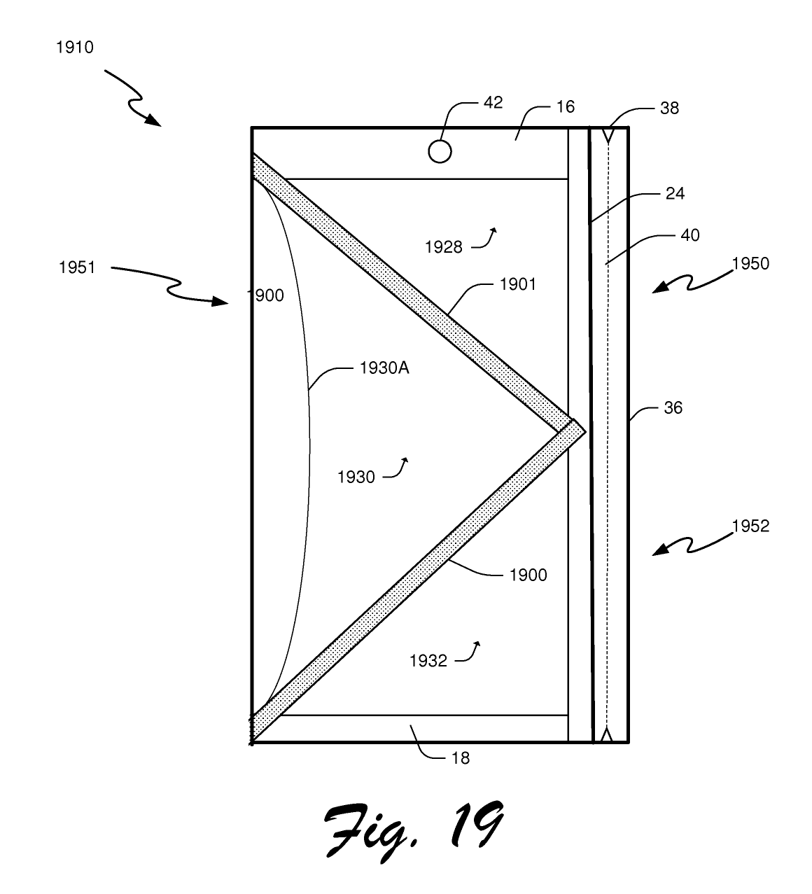

FIG. 18 shows yet another embodiment of the present invention. The container/bag 1810 is formed with having an open top side of the container/bag before filling occurs, and sides 1822, 1836 are sealed (such as by heat seal) along with a gusset 1840 and a peel-seal 1800. In an alternative embodiment, one or more sides 1822, 1836 does not require sealing as it may be formed by folding the bottom-side sheet over the top-side sheet and then a seal being added on the opposite side of the package. The folded-over approach may be utilized with any of the described embodiments herein, making one less seal per container/bag necessary. In the illustrated embodiment, the seal 1800 proceeds down each opening area 1841, 1842 of the gusset 1840 (as shown in the cross-sectional highlight), allowing a seal to be made thus isolating the compartments 1828, 1830. To load and complete the package, first and second foodstuffs are respectively added to the respective compartments 1828, 1830 and then a pre-closed zipper 1824 added and sealed to the top of the package. Alternatively, the zipper 1824 is not pre-closed but kept open, and the foodstuffs are loaded from the top, and then the zipper 1824 is closed and a heat seal is applied to the top.

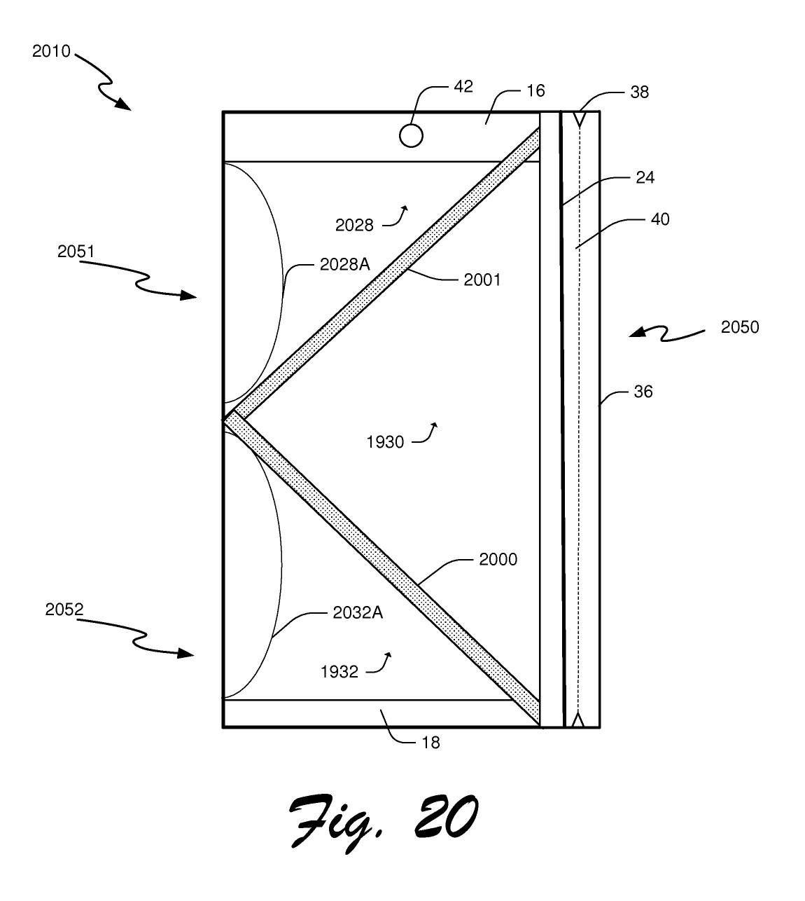

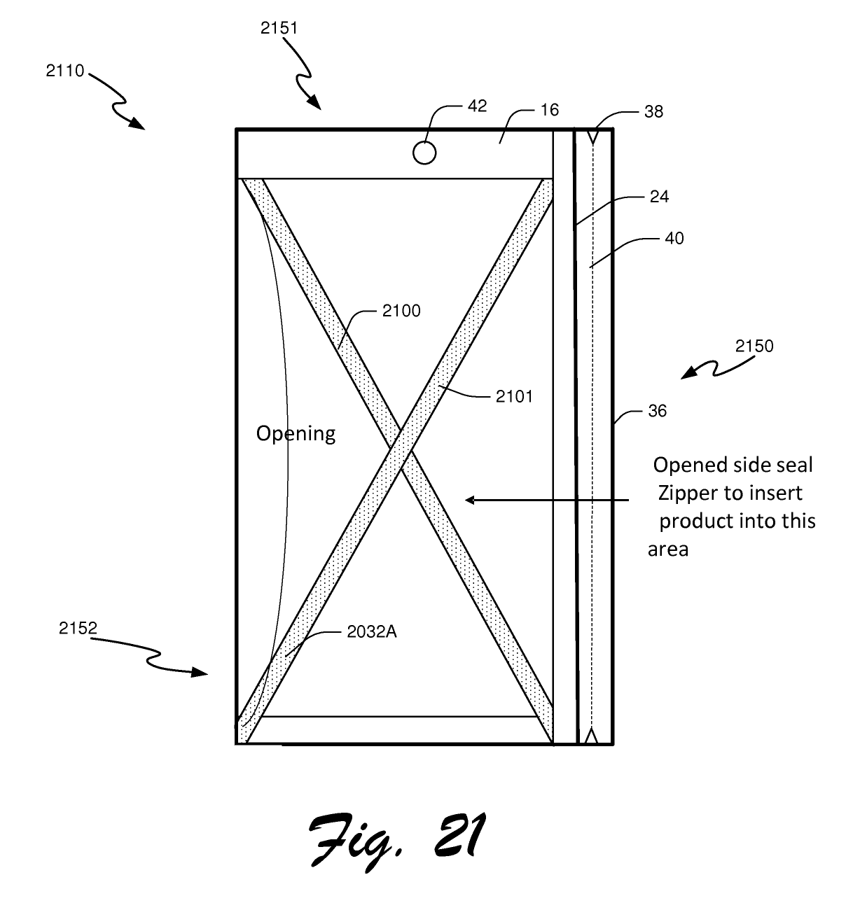

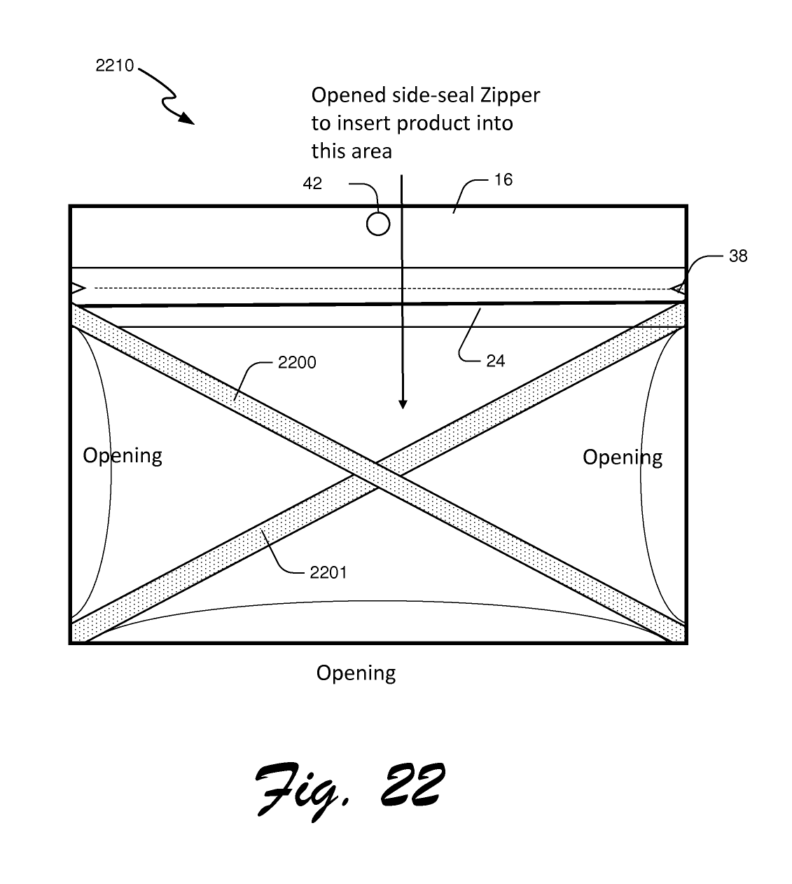

Any number of compartments may be utilized within the container/packaging bags of the present invention, along with any number of internal seals to segregate respective compartments from one another. The embodiment shown in FIG. 19 shows a bag 1910 with three compartments 1928, 1930, and 1932, formed, as those of skill in the art understand from additional disclosure herein, by techniques disclosed in relation to other embodiments. Two peelable joins are shown 1901, 1900, respectively creating segregated partitions between compartments 1928 and 1930, and then 1930 and 1932. Once the bag is formed by sealing the sides 16, 18, and adding seals 1900, 1901, foodstuffs are respectively loaded 1950, 1951, 1952 into compartments 1928, 1930, 1932, and then the join 24 can be added and sealed, closing compartments 1928, 1932, and the rear opening 1930A may be sealed (such as by a heat seal) enclosing compartment 1930. Similarly to other embodiments, if a consumer opens the sealed bag 1910, the peelable joins 1901, 1900 will separate, allowing the contents of the three compartments 1928, 1930, 1932 to become merged into a single compartment. Likewise, the bag configuration may be oriented as that shown in FIG. 20, where the joins 2000, 2001 create three compartments 2028, 2030, 2032, and loading (2050, 2051, 2052) respectively takes place through the yet-to-be closed zip closure 24 (2050) and openings 2028A (2051), 2032A (2052), and closures are obtained by heat seal or other techniques as described above. Similar Four-compartment versions are illustrated in FIGS. 21 and 22.

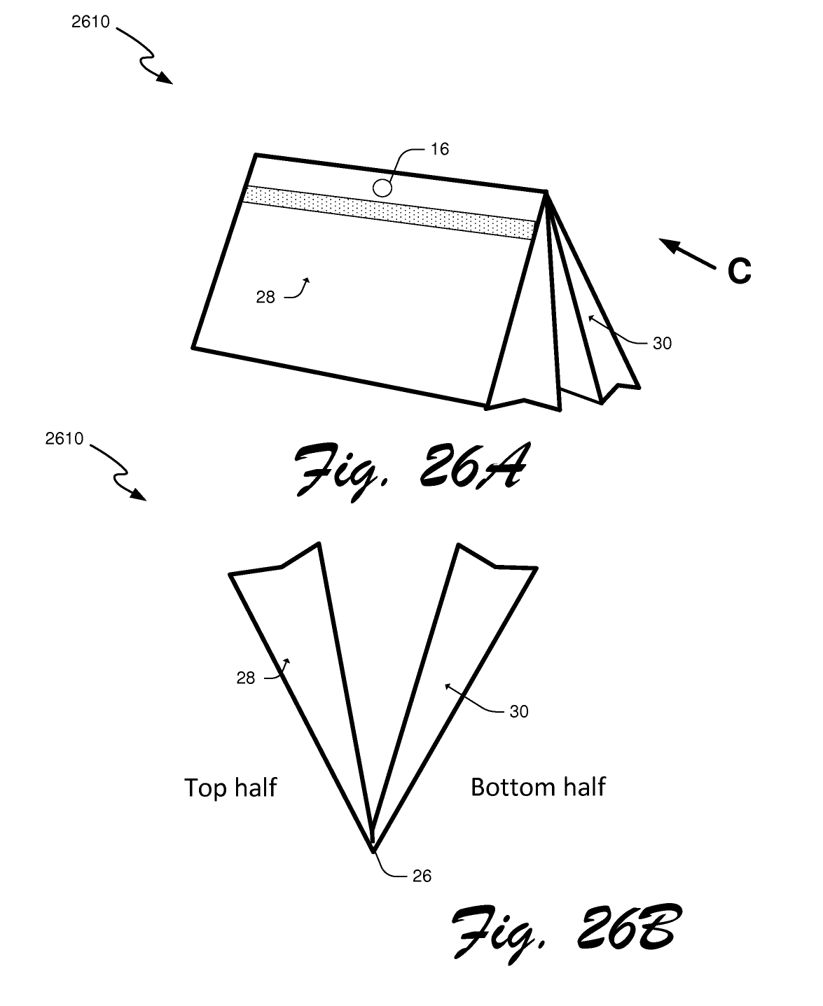

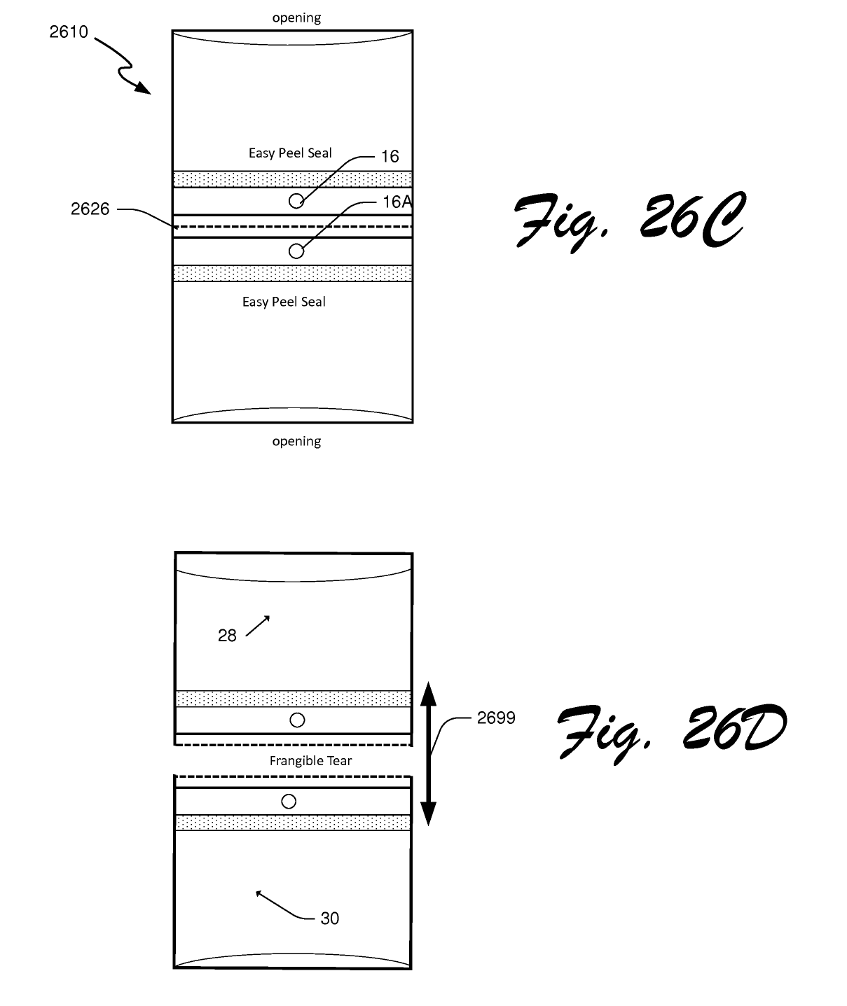

The illustrated embodiments in FIGS. 26A-D show a combination of features of aspects of the present invention (FIG. 26 B shows an end-on view as per letter “C”). A frangible seal 2626 separates the compartments 28, 30, allowing the compartments to be folded together as shown in FIGS. 26 A-B, and holes 16, 16A, allow hanging the folded configuration for display. The bag 2610 may also be separated 2699 as shown in FIG. 26D, along the frangible seal 2626, into two compartments 28, 30.

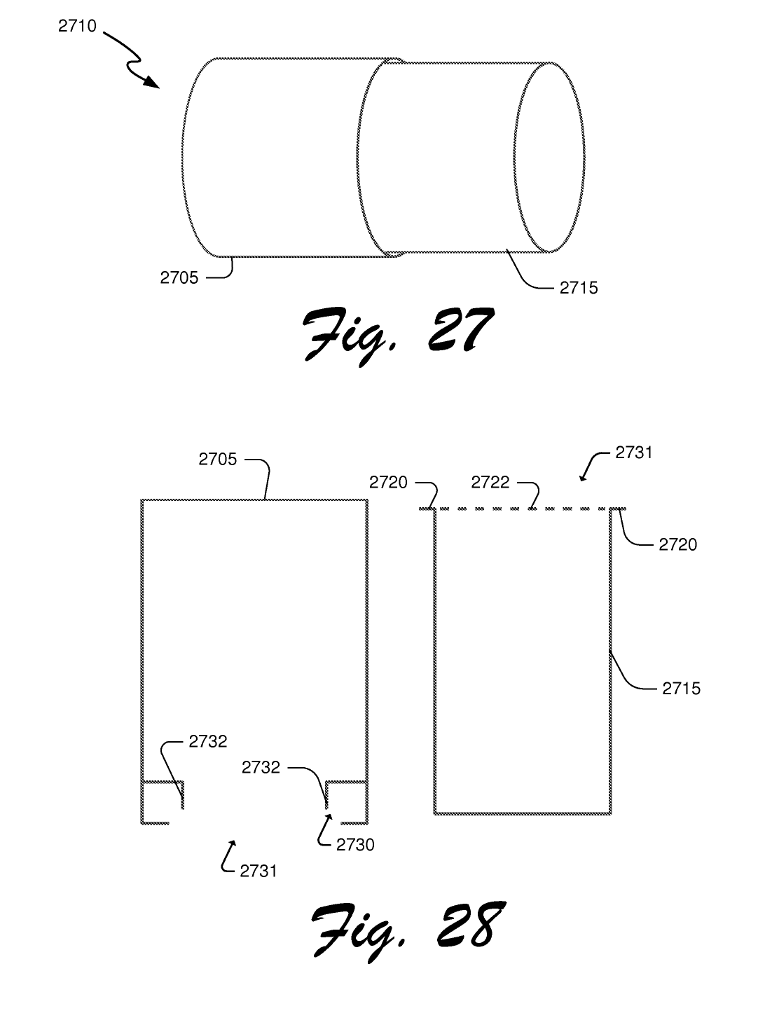

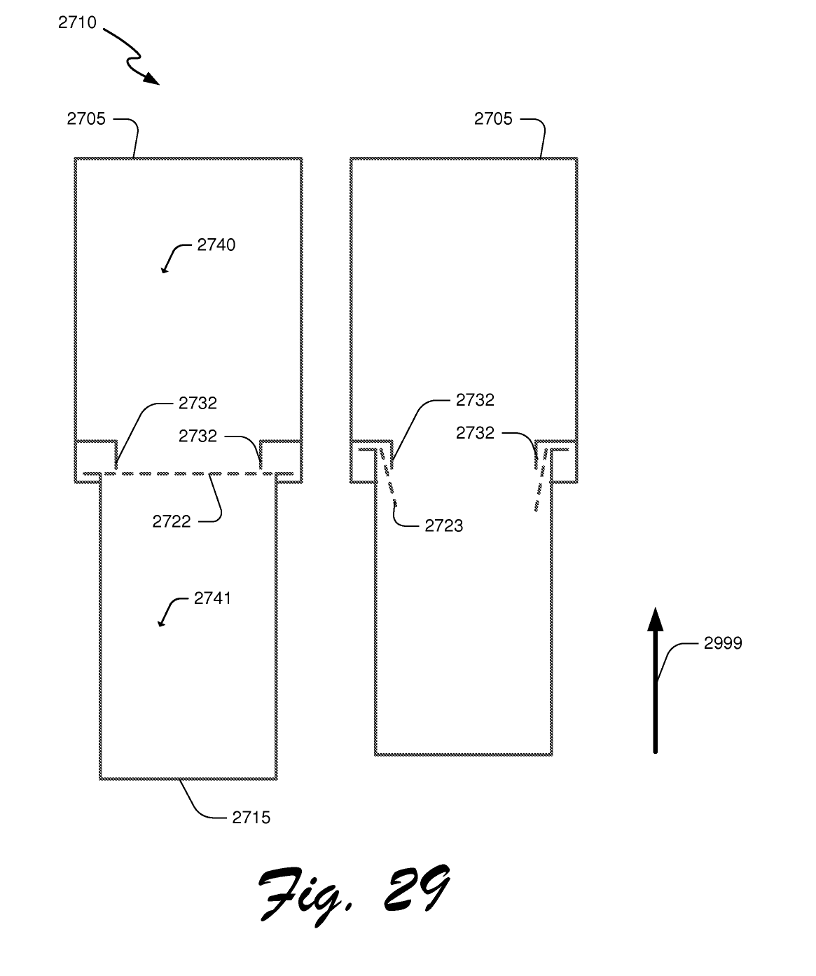

FIGS. 27-29 illustrate an alternate embodiment of a container having “nested” cylinders (each respectively having one open end and one closed end) forming two compartments with an interposed membrane seal. A first cylinder 2705 and a second cylinder 2715 are disposed such that the first cylinder has an interior diameter greater than an exterior diameter of the second cylinder (therefore allowing the second cylinder to slide “inside” the first. As the cross sectional diagram of FIG. 28 (with the cylinders separated) and cross sectional diagram in FIG. 29 (with the cylinders assembled) show, the second cylinder 2715 has an exteriorly-oriented flange 2720 proximate the open end of the second cylinder 2722 and a membrane seal 2722, such as plastic membrane adhered to the flange area and sealing the second cylinder. When nested, the open end 2723 of the second cylinder 2722 is disposed within at least one edge 2730 of the open end 2731 of the first cylinder proximate a tearing abutment 2732 disposed on an interior surface of the first cylinder proximate its open end. The central axis of the first cylinder and second cylinder are substantially aligned, forming the first interior compartment 2740 within the first cylinder 2705, and the second interior compartment 2741 within the second cylinder 2715. The first cylinder 2715 and second cylinder 2715 are disposed to be moved with respect to one another, whereby applying a force moving the closed ends of the first and second cylinders in a direction approaching one another (2999) causes an impingement of the tearing abutment 2732 on the membrane 2722, results in a rupture of the membrane 2722. With the ruptured membrane 2723 no longer sealing the second cylinder's opening, a single compartment is formed, and foodstuffs that had been respectively stored in the cavities 2740, 2741 may now be intermixed.

A bag embodied by the invention may also have more than two side by side interior compartments, the additional compartment(s) being formed by one or more further joins in the interior of the bag connecting the inner faces of the front and rear panels of the bag together. The joins can be the same or different to one another (e.g., formed by a peelable sealing film or a zipper type closure system as described above), and may all be arranged for being peeled at the same time or selectively in an order determined by the user to allow the contents of each of the side by side compartments to be mixed together. Typically, the respective joins will be arranged so as to be essentially parallel to one another, but non-parallel configurations may also be provided.

While the side by side compartments of a bag embodied by the invention will typically be at least partially filled with solid food items in use as described above, embodiments of the invention may be provided in which one or more of the side by side compartments are filled with an edible powder, semi-solid or liquid such as a seasoning, sauce, or dressing. For example, one of the compartments could be filled with a salad mix (e.g., a lettuce leaf mix), and another of the side by side compartments could contain a salad dressing or a mayonnaise. As another example, one compartment of the bag could be filled with a muesli mix or a cereal while another of the compartments may be filled with a yogurt. In various embodiments, one or all of the compartments of the bag may be filled with edible liquid(s) and/or flowable edible semi-solids such as a yogurt or a custard.

Likewise, embodiments of the invention are not limited to the use of bags as described herein for the packaging of edible items. For example, non-edible reagents could be packaged in different ones of the side by side compartments which when mixed together generate an endothermic or exothermic reaction in use, for use of the bag as a cold pack or heat pack. In such embodiments, the opposite side margins 16 and 18 as well as the top and bottom regions of the bag may be permanently sealed (e.g., heat sealed) against opening of the bag.

As such, although a number of embodiments of the invention have been described above, it will be understood that various modifications and changes may be made thereto without departing from the scope of the invention. Hence, the embodiments described above are only illustrative and are not to be taken as being restrictive. Changes and modifications may be made to the disclosed embodiments without departing from the scope of the present invention. These and other changes or modifications are intended to be included within the scope of the present invention, as expressed in the following claims.

What is claimed is:

1. A sealed food product container comprising:
a first inner compartment and a second inner compartment defined within an interior volume of the container;
an opening mechanism to provide access to the contents of the two or more inner compartments; and
wherein the first and second inner compartments are sealed and segregated to prevent migration of water from a first provided foodstuff stored within the first compartment to a second provided foodstuff stored within the second compartment.

2. The container according to claim 1, wherein the first provided foodstuff has a first a_{w} value that exceeds a second a_{w} of the second provided foodstuff.

3. The container accord to claim 2, wherein the first a_{w} is in the range of 0.6 to 0.8, and the second a_{w} is less than or equal to 0.60.

4. The container accord to claim 2, wherein the first a_{w} is in the range of 0.75 to 0.8, and the second a_{w} is less than or equal to 0.75.

5. The container according to claim 2, wherein the first provided foodstuff comprises dried meat pieces, and the second provided foodstuff comprises one or more trail mix components.

6. The container according to claim 3, wherein the one or more trail mix components comprise one or more of nuts, seeds, dried fruit, dried vegetables, chocolate pieces, carob pieces, candy pieces, dried wasabi pieces, and processed or unprocessed grains.

7. The container according to claim 1, wherein the container comprises a flexible packaging bag, the bag comprising:
opposed front and rear panels and having opposite side margins and opposite end regions interconnecting the side margins, each of the panels having a respective outside face and a respective opposite inside face, wherein:
the respective inside faces of the panels are connected together by a join dividing the interior of the bag into side by side compartments comprising the respective first and second compartments;
the panels are configured to be peelable apart from one another along the join to form a single interior compartment of the bag from the first and second side-by-side compartments.

8. The container according to claim 7, wherein the opening mechanism comprises one of: a resealable zip-type closure, a slide-zip-type closure, an adhesive material that may be opened through peeling apart at least a portion of the front and rear panels, a destructive tear-through panel; and an adhesive material with residual tack that allows for reclosure after initial opening by a consumer.

9. The container according to claim 7, wherein the bag is configured to be opened at one of the end regions of the bag for access into an interior space interior of the bag.

10. The container according to claim 7, further comprising a gusset disposed proximal to one of a side margin or a bottom end region of the bag.

11. The container according to claim 7, wherein the join comprises one of a perforation and a frangible material allowing for the bag to be separated into at least two components by the consumer, each of the respective two components comprising one of the first and second interior spaces.

12. The container according to claim 11, wherein the bag is provided with a scoring allowing for foldability along an axis perpendicular to the major long axis, the foldable area proximate the join.

13. The container according to claim 7, further comprising a third inner compartment defined within an interior volume of the container.

14. The container according to claim 7, further comprising a fourth inner compartment defined within an interior volume of the container.

15. The container according to claim 7, wherein the join comprises one of a resealable zip-type closure, an adhesive material that may be opened through peeling apart at least a portion of the front and rear panels, a destructive tear-through frangible seal; and an adhesive material with residual tack that allows for reclosure after initial opening by a consumer.

16. The container according to claim 15, wherein the bag comprises two or more joins disposed in an essentially parallel manner within an interior volume of the bag so that when the bag is opened by a consumer, the two or more joins will separate and provide access to all footstuff contents within any compartment of the bag.

17. The container according to claim 15, wherein the bag comprises two or more joins disposed in an intersecting manner, the intersection of the joins being one of orthogonal or non-orthogonal crossing, the joins disposed within an interior volume of the bag so that when the bag is opened by a consumer, the two or more joins will separate and provide access to all footstuff contents within any compartment of the bag.

18. The container according to claim 1, further comprising:
a first cylinder and a second cylinder each respectively having an open end and a closed end thereof;
the first cylinder having an interior diameter greater than an exterior diameter of the second cylinder;
the second cylinder having an exteriorly oriented flange proximate the open end of the second cylinder and a seal applied thereto;
the open end of the second cylinder disposed within at least one edge of the open end of the first cylinder proximate a tearing abutment disposed on an interior surface of the first cylinder proximate its open end;
whereby the central axis of the first cylinder and second cylinder are substantially aligned, forming the first interior compartment within the first cylinder, and the second interior compartment within the second cylinder;
wherein the first cylinder and second cylinder disposed to be moved with respect to one another, whereby applying a force moving the closed ends of the first and second cylinders in a direction approaching one another results in a rupture of the membrane.

19. A method for fabricating a sealed food product container with provided foodstuffs, the method comprising:
selecting a sheet material for fabrication of a flexible packaging bag;
affixing a provided closure device to a first layer of the sheet material;
applying one of a sealant film and an adhesive to the sheet material for forming a removable join that is to be disposed within two or more segregated interior compartments of the flexible packaging bag, the join disposed as to one of prevent or restrict water migration between the respective interior compartments before the bag is opened by a consumer;
overlaying a second layer of the sheet material on top of the first layer to form an opposite panel of the bag;
affixing the second layer of the sheet material to the closure device and the one of the sealant film and adhesive, thereby forming the join to create a consumer-removable seal between the first and second interior compartments, the join to be removable by the consumer to allow contents between the first and second interior compartments to be merged;
creating the first and second interior spaces having respective loading openings;
filling the respective first and second interior spaces with respective first and second provided foodstuffs, by respectively passing the foodstuffs through the respective loading openings, the respective first and second foodstuffs having disparate a_{w} values; and
sealing the loading openings to form a sealed end region of the bag.

20. The method according to claim 19, wherein creating the first and second interior spaces having respective loading openings further comprises forming respective opposite side margins by sealing together the first layer and second layers of the sheet material to form a top side margin and opposed peripheral side margins, thereby creating the first and second interior spaces having respective loading openings proximate a bottom end region.

21. The method according to claim 19, wherein creating the first and second interior spaces having respective loading openings further comprises forming respective opposite side margins by sealing together the first layer and second layers of the sheet material to form a an opening margin and opposed sealed margins, thereby creating the first and second interior spaces having respective loading openings respectively proximate to side margins of the bag.

22. The method according to claim 19, wherein:
the sealing of the first layer and second layer is provided by one of a heat seal and a seal created by an interposing adhesive; and
the sealing of the first and second compartments is provided by one of a heat seal and a seal created by an interposing adhesive.

23. The method according to claim 19, wherein the closure device comprises one of:
a resealable zip-type closure; and
an adhesive material with residual tack that allows for reclosure after initial opening by the consumer.

24. The container according to claim 19, wherein the first provided foodstuff comprises dried meat pieces, and the second provided foodstuff comprises one or more trail mix components.

25. The container according to claim 24, wherein the one or more trail mix components comprise one or more of nuts, seeds, dried fruit, dried vegetables, chocolate pieces, carob pieces, candy pieces, dried wasabi pieces, and processed or unprocessed grains.

26. The method according to claim 19, further comprising a gusset disposed proximal to one of a side margin or a bottom end region of the bag.

27. The method according to claim 19, wherein the join comprises one of a perforation and a frangible material allowing for the bag to be separated into at least two components by the consumer, each of the respective two components comprising one of the first and second interior spaces.

28. The method according to claim 27, wherein the bag is provided with a scoring allowing for foldability along an axis perpendicular to the major long axis, the foldable area proximate the join.

29. The method according to claim 27, wherein forming respective opposite side margins by sealing together the first layer and second layers of the sheet material to form a top side margin and opposed peripheral side margins, thereby creating the first and second interior spaces having respective loading openings.

30. The method according to claim 27, further comprising:
coupling provided first and second hoppers respectively holding the first and second foodstuffs to two scales;
respectively weighing, through the coupled scales, predetermined respective packing weights the first and second foodstuffs;
respectively dispensing the first and second foodstuffs into two funnels respectively coupled to the scales, the funnels disposed so as to align the respective outputs of the funnels with respective openings in the container;
dispensing the first and second foodstuffs respectively into first and second interior spaces of the container; and
sealing the openings in the container.
